(19) United States
(12) Patent Application Publication
(10) Pub. No.: US 2025/0054489 A1
(43) Pub. Date: Feb. 13, 2025

(54) System and Method for Mapping Phonemes to Acoustic Symbols and Codes

(71) Applicant: Ashwin Rao, Seattle, WA (US)

(72) Inventor: Ashwin Rao, Seattle, WA (US)

(21) Appl. No.: 18/797,614

(22) Filed: Aug. 8, 2024

Related U.S. Application Data
(60) Provisional application No. 63/531,804, filed on Aug. 9, 2023.

(51) Int. Cl. G10L 15/02; G10L 15/30

(52) U.S. Cl. CPC G10L 15/02; G10L 15/30; G10L 2015/025

(57) ABSTRACT

A hybrid vector representation for speech resonances is defined using the modulation model and the sum of sinusoids model. An adaptive filter bank, whose channels utilize resonance localized modulation tracking, to robustly estimate temporal variations in these vectors, is then presented. The synchrony in modulations, within and across resonance channels, is subsequently used to derive acoustic symbols and codes that map fundamental units of languages, phonemes. Such an acoustic-phonetic mapping has never been demonstrated before. It has potential applications in speech recognition and voice analytics.

### CROSS-REFERENCE TO RELATED APPLICATIONS

This patent application claims priority to U.S. Provisional Patent Application No. 63,531,804, filed Aug. 9, 2023, which is incorporated herein by reference in its entirety; a scientific paper based on the patent application has been published in the Proceedings of the International Speech Communication Association (ISCA), Interspeech-2023 Aug. 20-24, Dublin, Ireland.

### FIELD OF THE INVENTION

The invention relates to methods for extracting patterns from speech waveforms.

### BACKGROUND

Big-data systems that are currently used in applications like speech recognition lack human-like performance and efficiency-their accuracy is susceptible to model mismatch, they fail to provide reliable feedback for error-correction, and they are very expensive to develop and deploy. Some references include: (a) X. Huang, J. Baker, and R. Reddy, “A historical perspective of speech recognition,” Communications of the ACM, vol. 57, no. 1, pp. 94-103, January 2014; (b) B. S. Atal, “Automatic speech recognition: A communication perspective,” Proceedings of the IEEE ICASSP, vol. 1, pp. 457-460, May 1999; (c) A. Rao, B. Roth, V. Nagesha, D. McAllaster, N. Liberman, and L. Gillick, “Large vocabulary continuous speech recognition of read speech over cellular and landline networks,” Proceedings of the ICSLP, pp. 402-405, October 2000; and (d) L. R. Rabiner and R. W. Schafer, “An introduction to digital speech processing,” Foundations and Trends in Signal Processing, vol. 1, no. 1-2, pp. 1-194, 2007.

To address these problems, research on finding new acoustic cues in speech, which better map phonemes, has been underway for over a century. Many of these approaches are motivated by the way humans recognize phonemes, followed by syllables, words, sentences, and meaning. Major strides have been made by several researchers, and some references include: (a) H. Fletcher, “The relative difficulty of interpreting the spoken sounds of English,” Physical Review, vol. 15, pp. 413-516, November 1920; (b) G. Fant, “Half a century in phonetics and speech research,” Fonetik 2000, Swedish phonetics meeting in Sk″ovde, pp. 2852-2861 May 2000; (c) N. Mesgarani, S. David, and S. Shamma, “Representation of phonemes in primary auditory cortex: How the brain analyzes speech,” Proceedings of the IEEE ICASSP, vol. 4, pp. 765-768, May 2007; (d) A. Lahiri and H. Reetz, “Distinctive features: Phonological underspecification in representation and processing,” Journal of Phonetics, vol. 38, pp. 44-59, January 2010; (e) J. B. Allen, “How do humans process and recognize speech?,” IEEE Transactions on Speech and Audio Processing, vol. 2, no. 4, pp. 567-577, October 1994; (f) A. M. Liberman, F. S. Cooper, D. P. Shankweiler, and M. Studdert-Kennedy, “Perception of the speech code,” Psychological Review, vol. 74, pp. 431-461, May 1967; (g) S. E. Iblumstein and K. N. Stevens, “Phonetic features and acoustic invariance in speech,” Cognition, vol. 10, no. 1, pp. 25-32, 1981; (h) J. B. Allen and F. Li, “Speech perception and cochlear signal processing,” IEEE Signal Processing Magazine, vol. 26, pp. 73-77, July 2009; (i) F. Li, A. Trevino, A. Menon, and J. B. Allen, “A psychoacoustic method for studying the necessary and sufficient perceptual cues of American English fricative consonants in noise,” J. of the Acous. Soc. of America, vol. 132, pp. 2663-2675 October 2012; and (j) H. Reetz and A. Jongman, Phonetics: Transcription, Production, Acoustics, and Perception, John Wiley and Sons, Hoboken, New Jersey, 2020.

Their speech analysis experiments primarily rely on acoustic features estimated using the spectrogram, the linear prediction spectrum, and auditory filter banks; their respective references are: (a) L. Cohen, Time Frequency Analysis, Prentice-Hall, Englewood Cliffs, New Jersey, 1995); (b) B. S. Atal and S. L. Hanauer, “Speech analysis and synthesis by linear prediction of the speech wave,” J. of the Acous. Soc. Of America, vol. 50, pp. 637-655, August 1971; and (c) A. Katsiamis, E. Drakakis, and R. Lyon, “Practical gammatone-like filters for auditory processing,” EURASIP Journal on Audio, Speech, and Music Processing, December 2007, 063685, 2007.

Unfortunately, successful mapping of phonemes has not been possible yet, due to a) high variability of existing speech features across speakers, phoneme context, and noise, and b) limitations of time-frequency analysis tools to jointly model phoneme transitions and resonances.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1: ONE EMBODIMENT OF THE TRAVELLINGWAVE FILTER BANK FOR MAPPING PHONEMES TO ACOUSTIC SYMBOLS AND CODES;

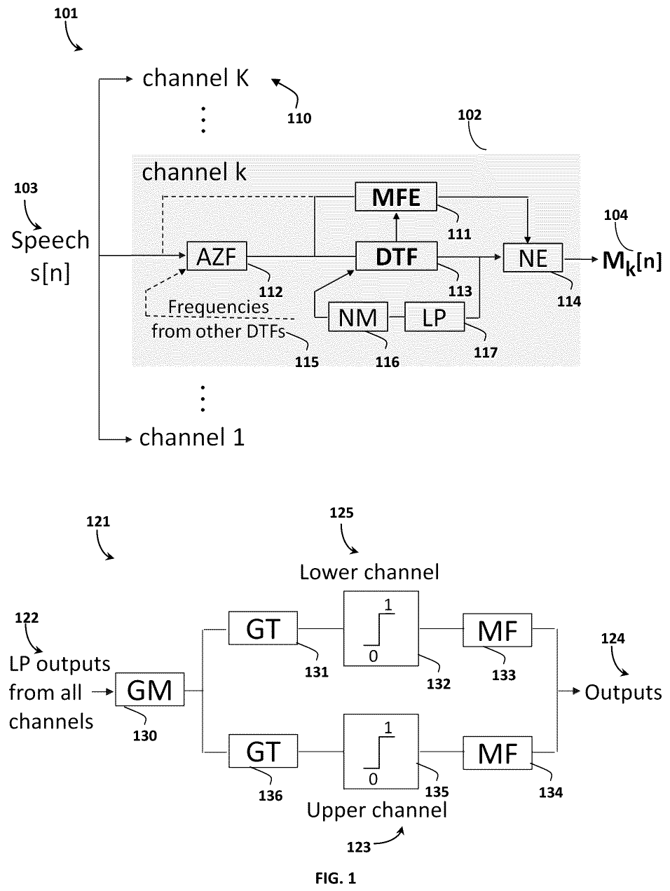

FIG. 2: ONE EMBODIMENT OF THE SYMBOL FOR IY-SH-IY;

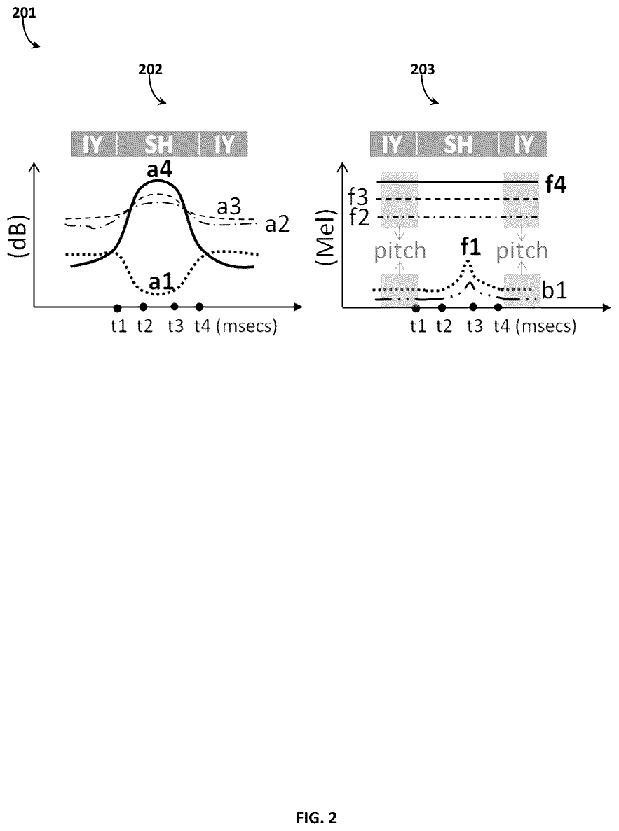

FIG. 3: SIMULATION RESULTS FOR IY-SH-IY EXAMPLE;

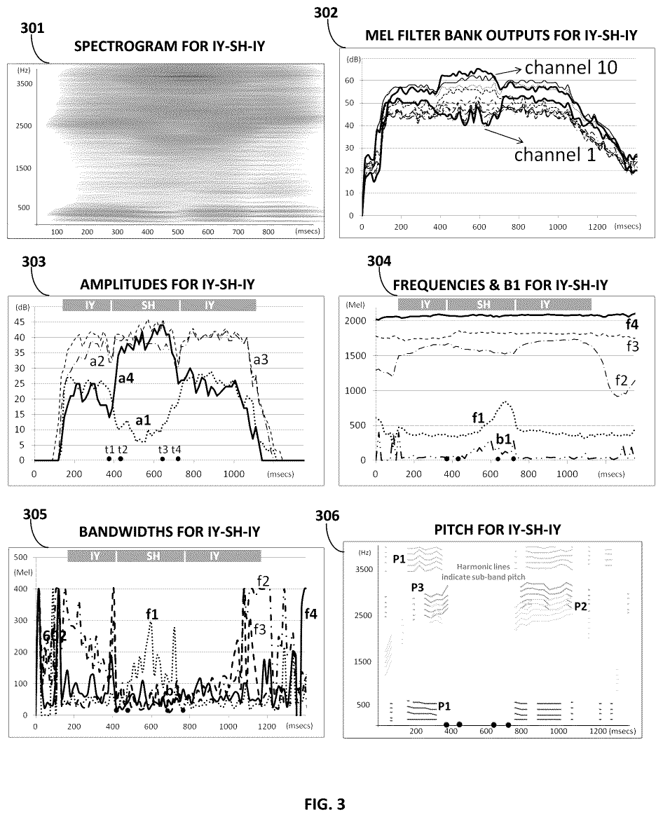

FIG. 4: NOISE SIMULATION RESULTS;

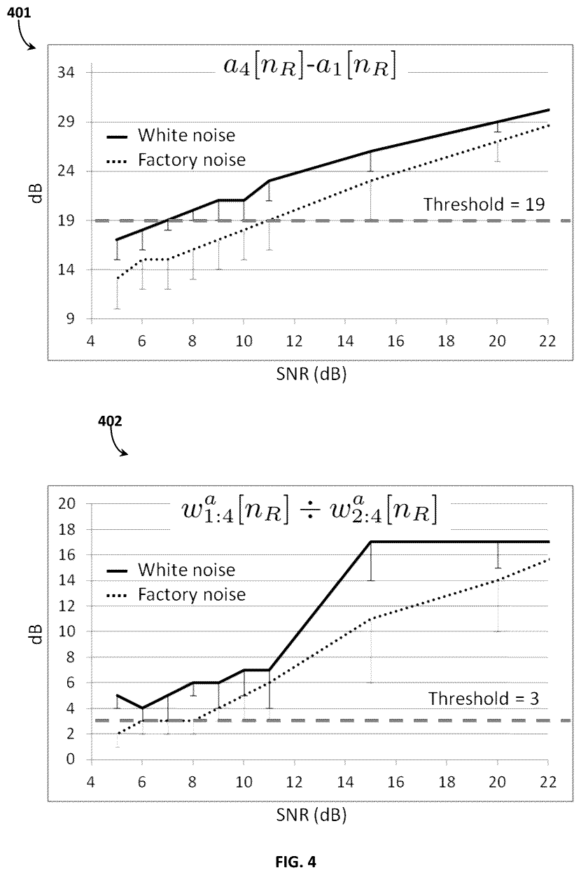

FIG. 5: MFB OUTPUT FOR SIGNAL WITH TWO RESONANCES;

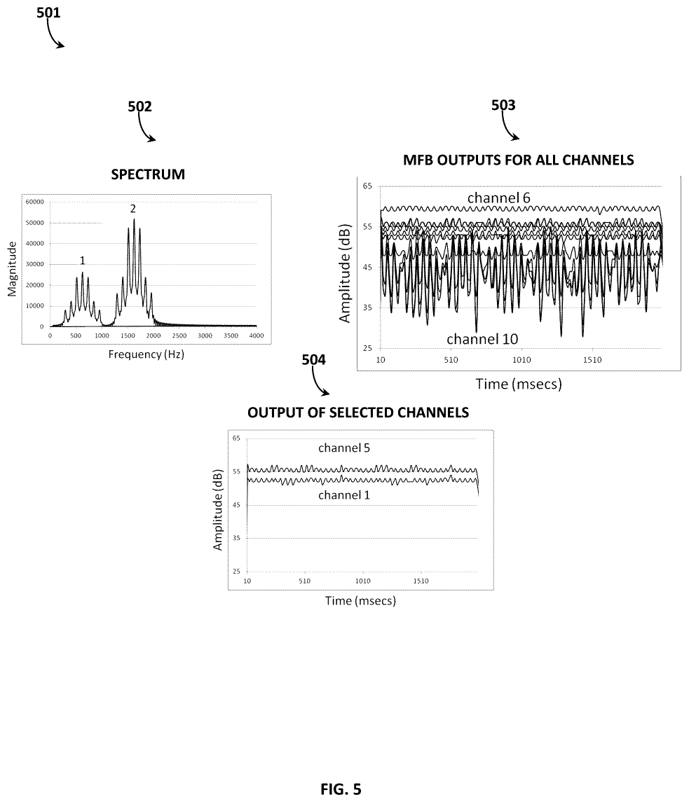

FIG. 6: MFB OUTPUT FOR SIGNAL WITH FOUR RESONANCES;

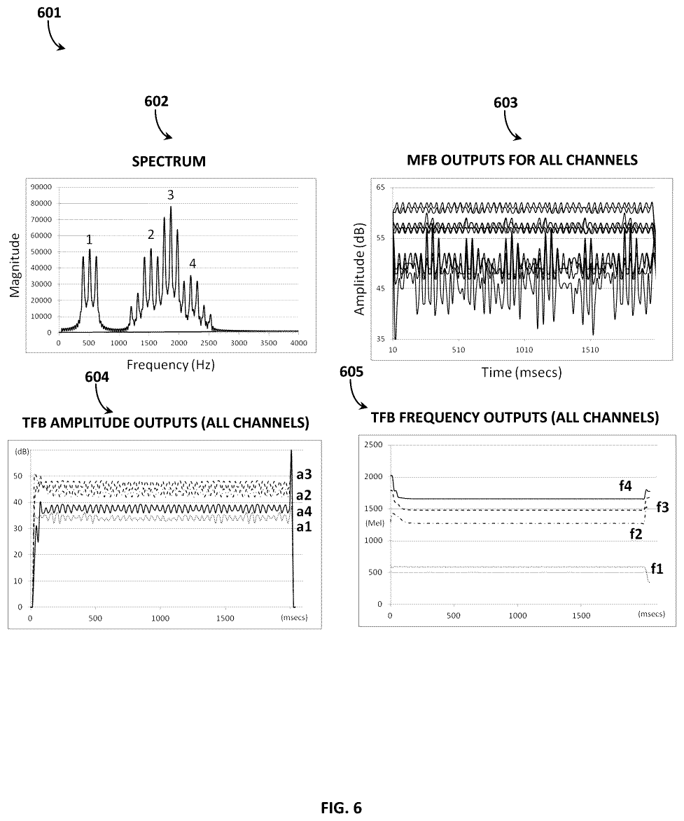

FIG. 7: ONE EMBODIMENT OF THE SYMBOL FOR AA-SH-AA;

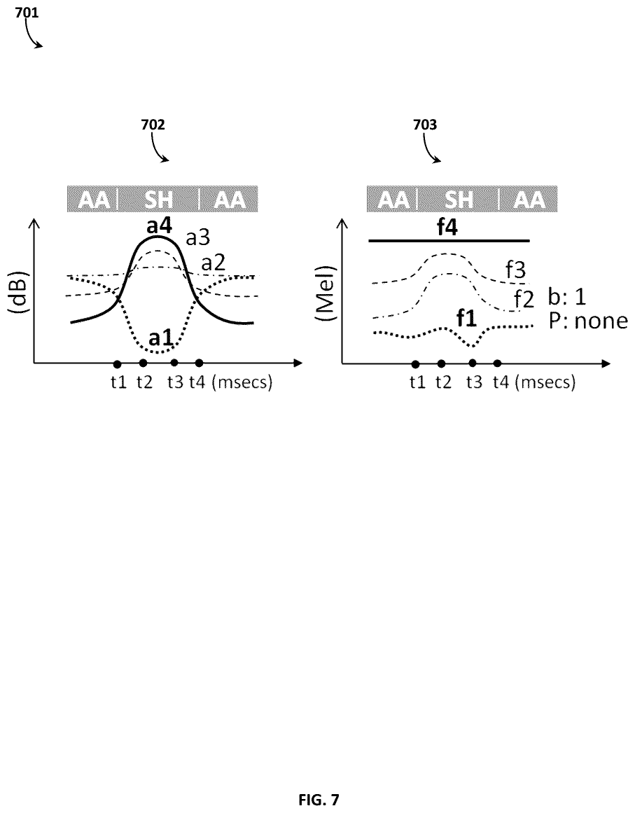

FIG. 8: SIMULATION RESULTS FOR AA-SH-AA EXAMPLE;

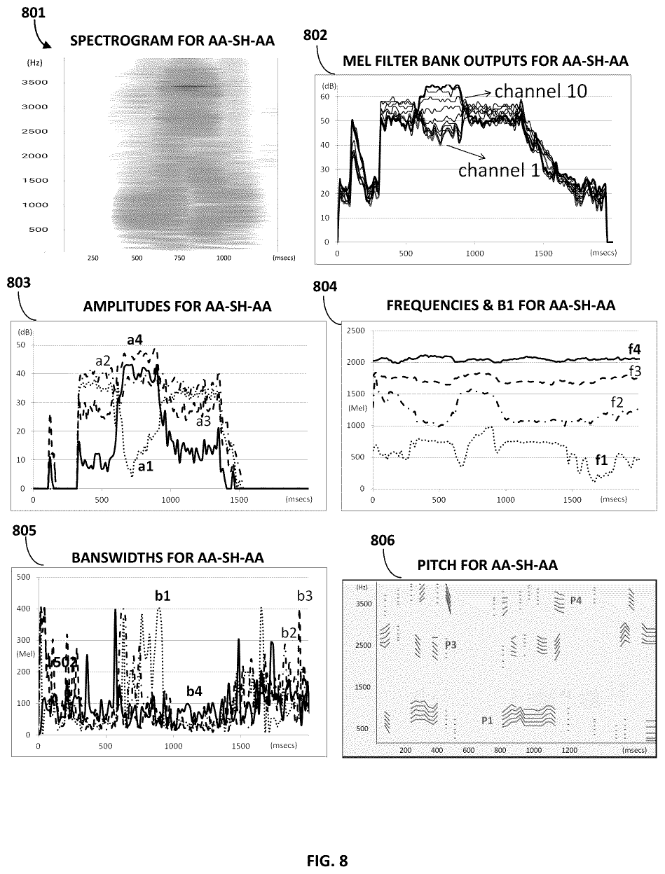

FIG. 9: ONE EMBODIMENT OF THE SYMBOL FOR AA-T-AA;

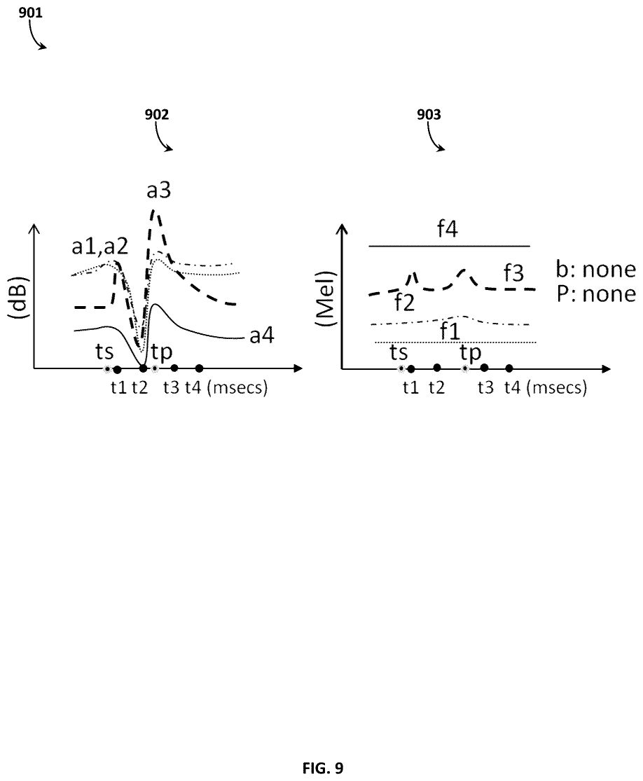

FIG. 10: SIMULATION RESULTS FOR AA-T-AA EXAMPLE;

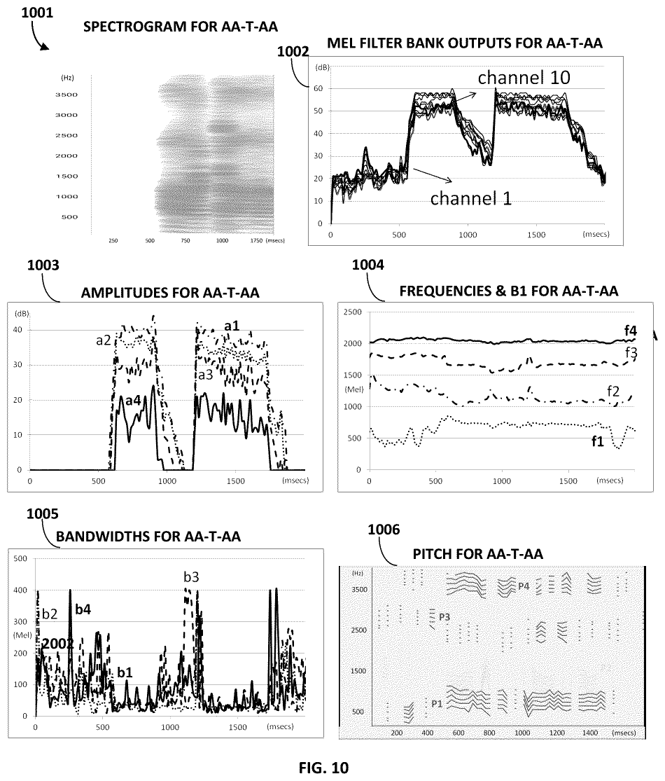

FIG. 11: ONE EMBODIMENT OF THE SYMBOL FOR AA-R-AA;

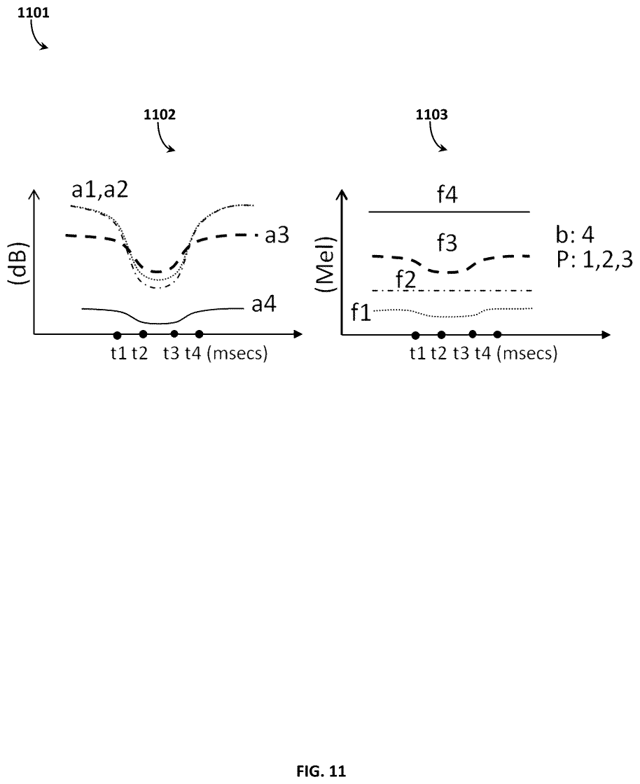

FIG. 12: SIMULATION RESULTS FOR AA-R-AA EXAMPLE;

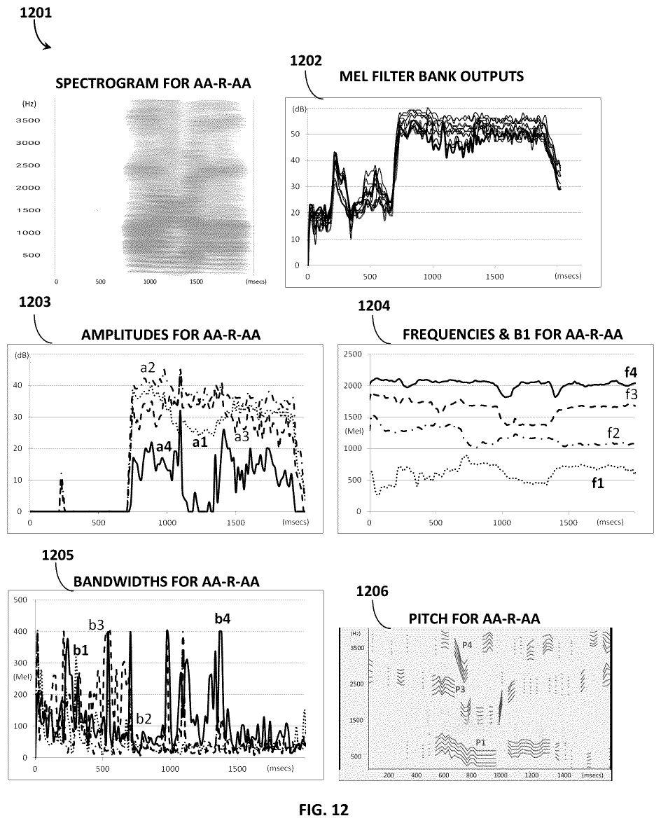

FIG. 13: ONE EMBODIMENT OF THE SYMBOL FOR AA-UW-AA;

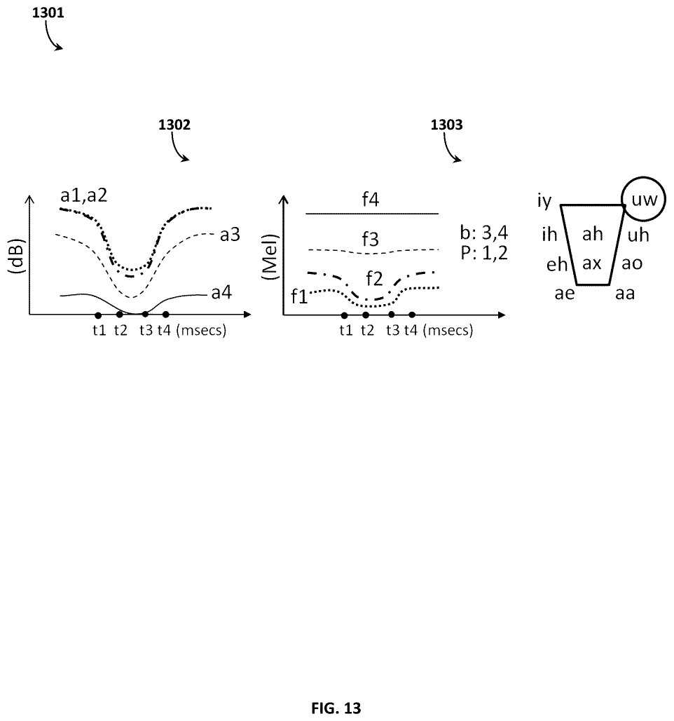

FIG. 14: SIMULATION RESULTS FOR AA-UW-AA EXAMPLE;

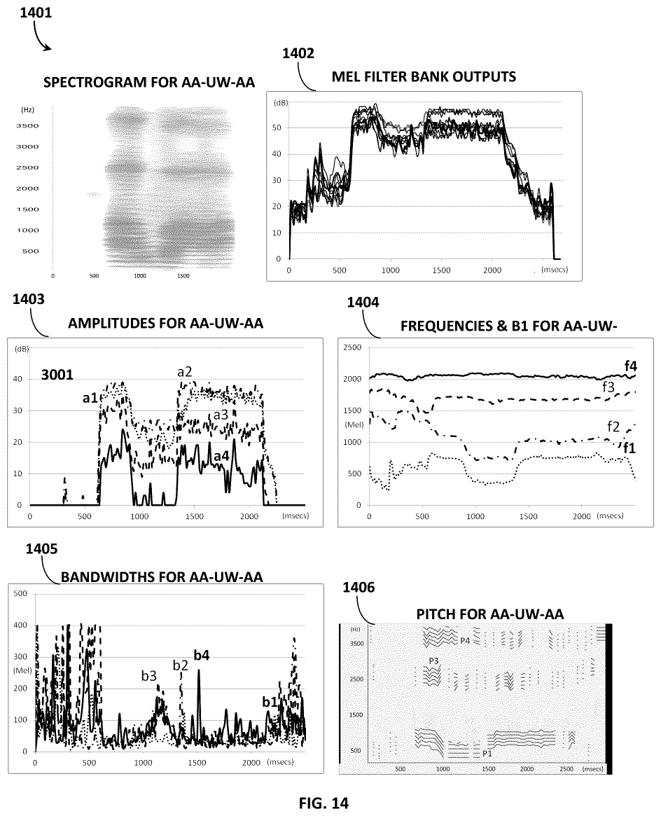

FIG. 15: CONFIDENCE ANALYSIS AND BENCHMARKING RESULTS;

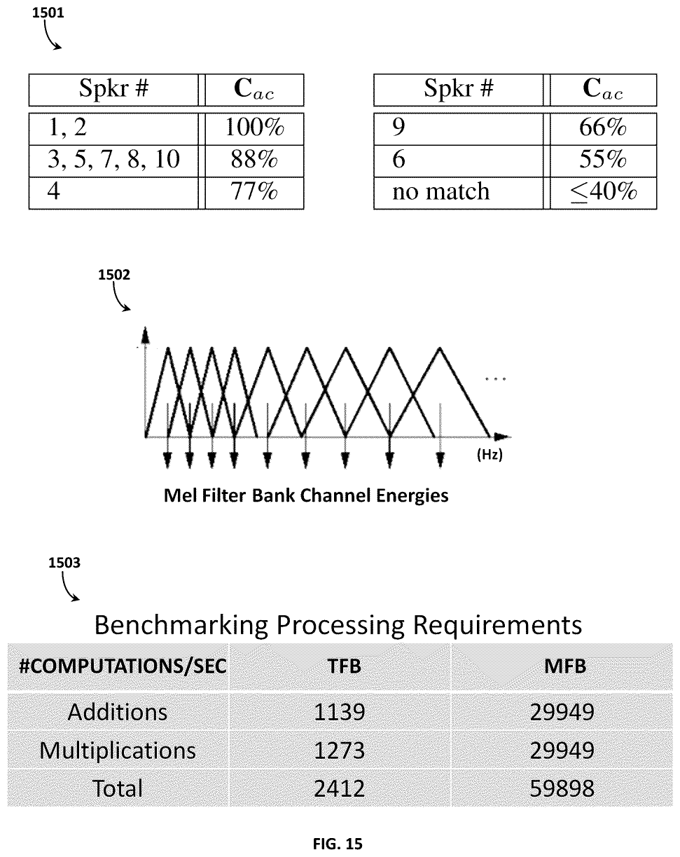

FIG. 16: ANALYSIS OF THE TFB ALGORITHM;

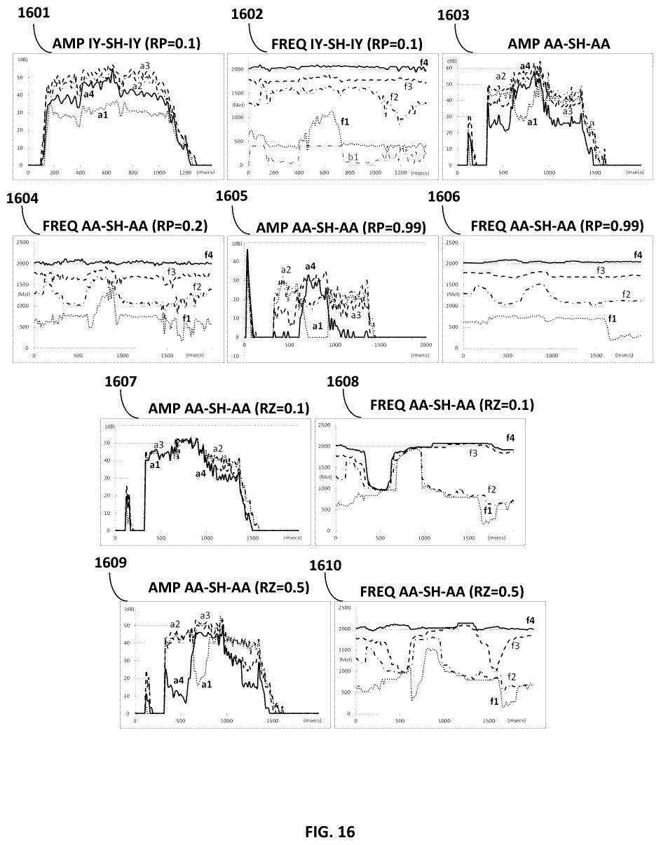

FIG. 17: EMBODIMENTS OF SYMBOLS FOR AA AND AA-ZH-AA;

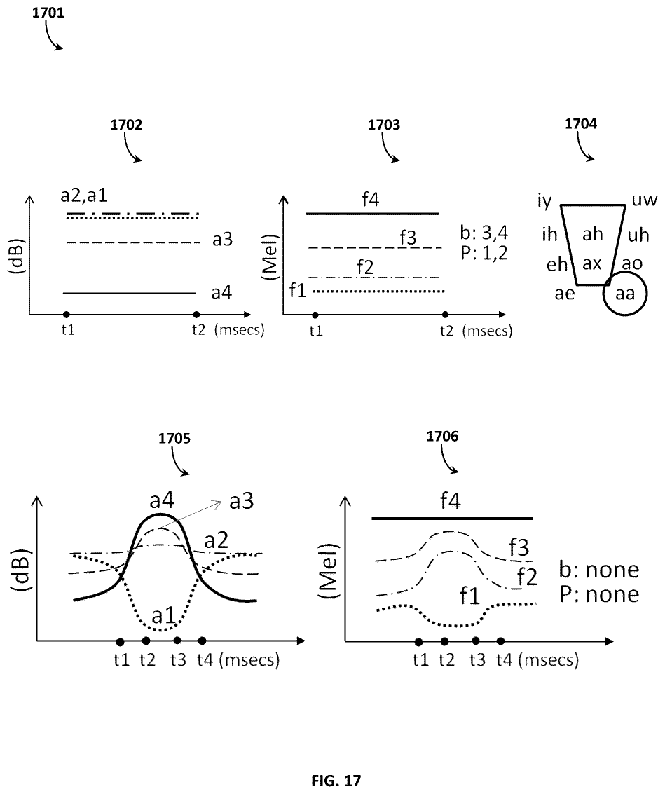

FIG. 18: EMBODIMENTS OF SYMBOLS FOR AA-CH-AA AND AA-JH-AA;

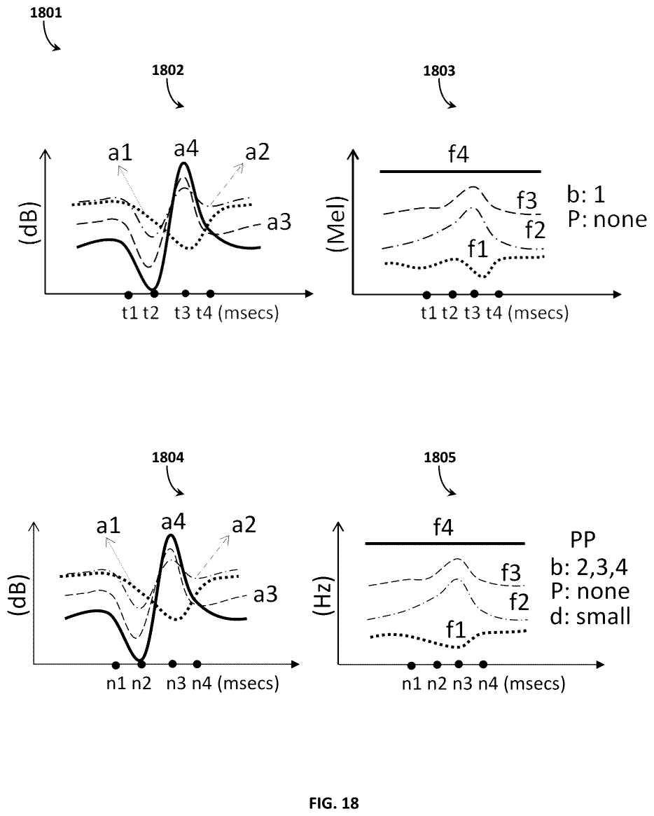

FIG. 19: EMBODIMENTS OF SYMBOLS FOR AA-S-AA AND AA-Z-AA;

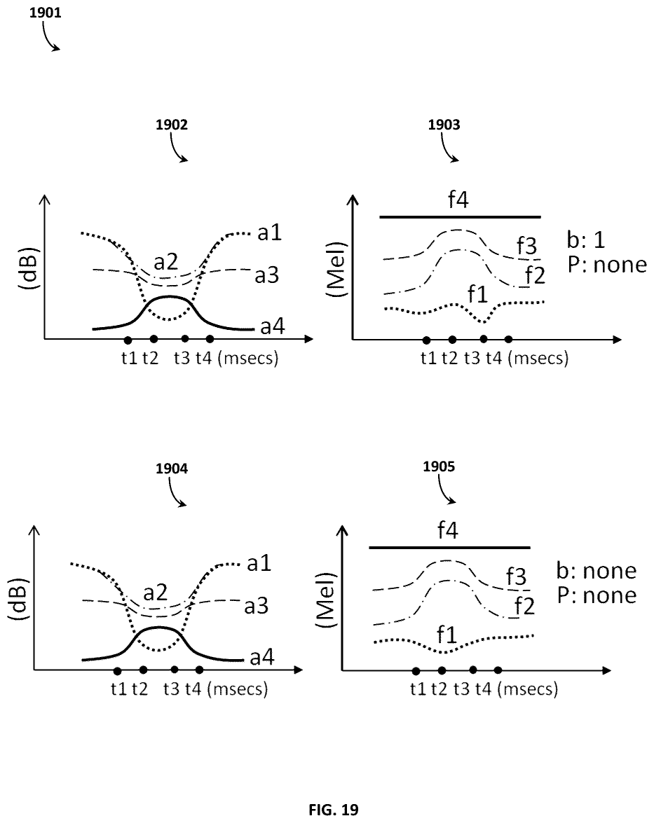

FIG. 20: EMBODIMENTS OF SYMBOLS FOR AA-F-AA AND AA-V-AA;

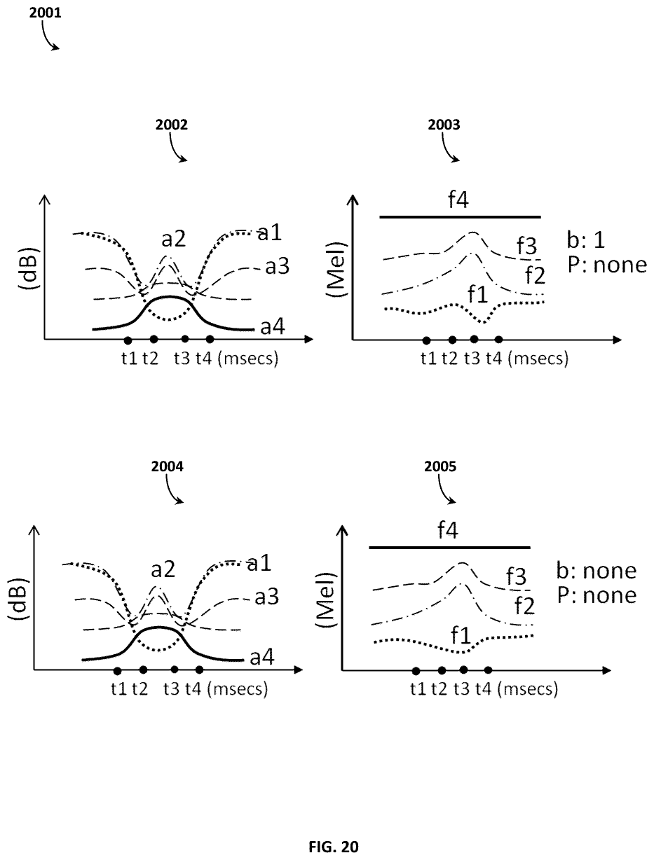

FIG. 21: EMBODIMENTS OF SYMBOLS FOR AA-H-AA AND AA-IY-AA;

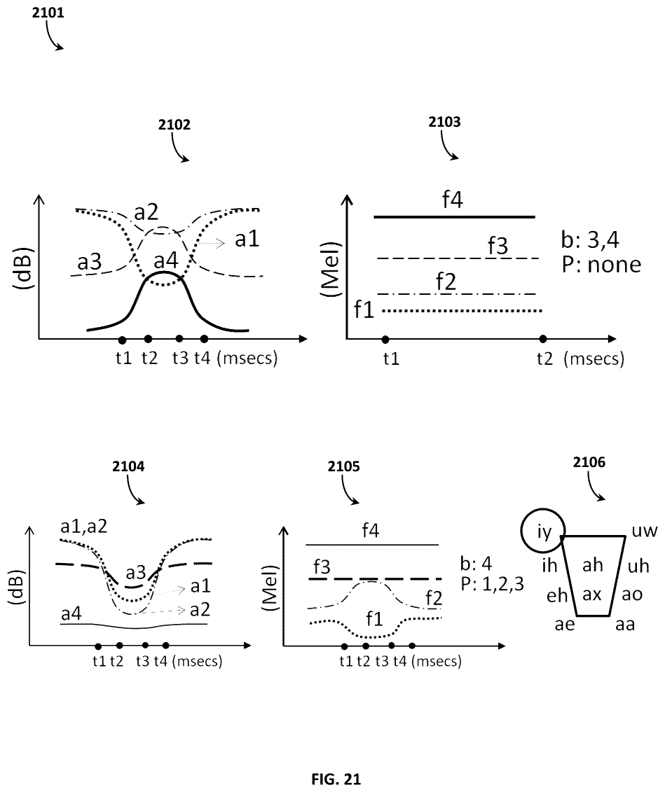

FIG. 22: EMBODIMENTS OF SYMBOLS FOR AA-Y-AA AND AA-W-AA;

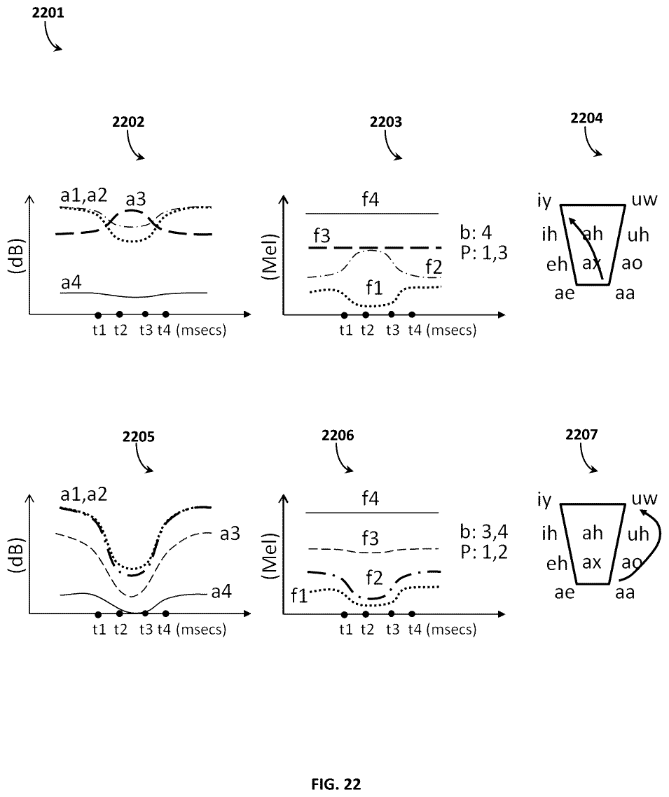

FIG. 23: EMBODIMENTS OF SYMBOLS FOR AA-M-AA AND AA-N-AA;

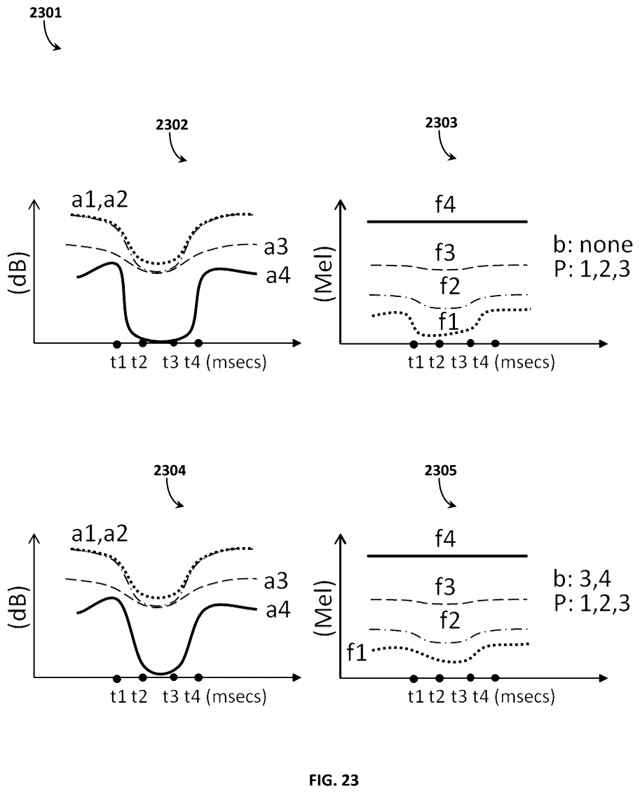

FIG. 24: EMBODIMENTS OF SYMBOLS FOR AA-L-AA AND AA-D-AA;

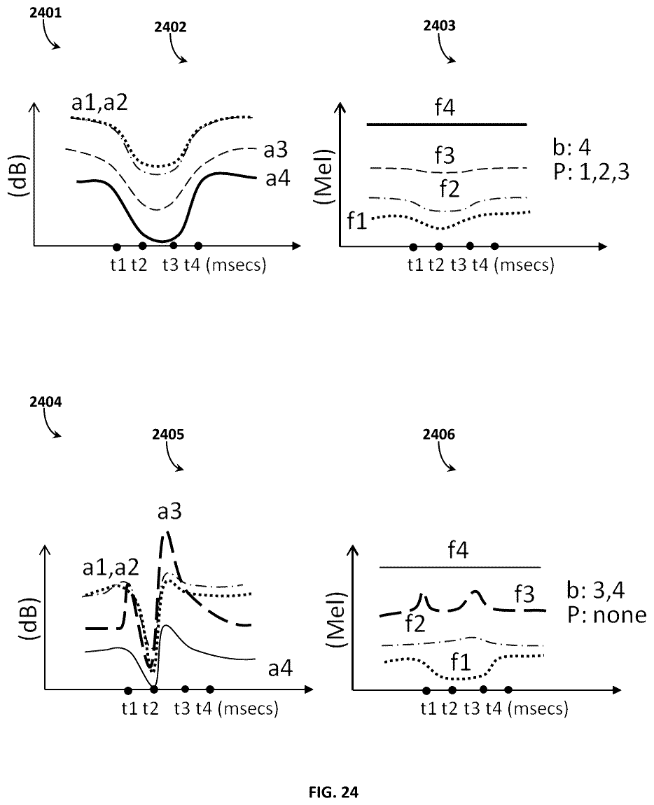

FIG. 25: EMBODIMENTS OF SYMBOLS FOR AA-K-AA AND AA-G-AA;

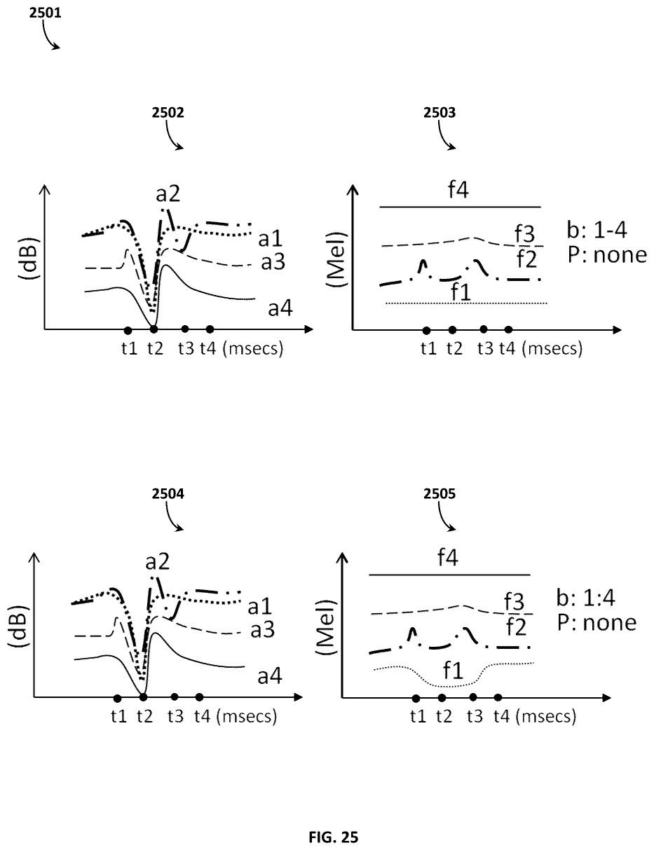

FIG. 26: EMBODIMENTS OF SYMBOLS FOR AA-P-AA AND AA-B-AA;

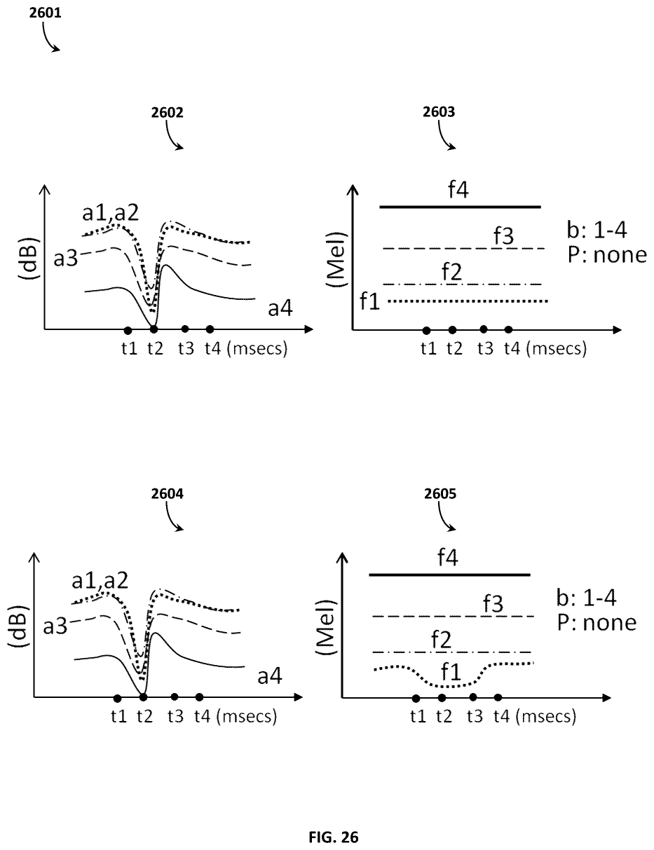

FIG. 27: EMBODIMENTS OF SYMBOLS FOR AA-TH-AA AND AA-DH-AA;

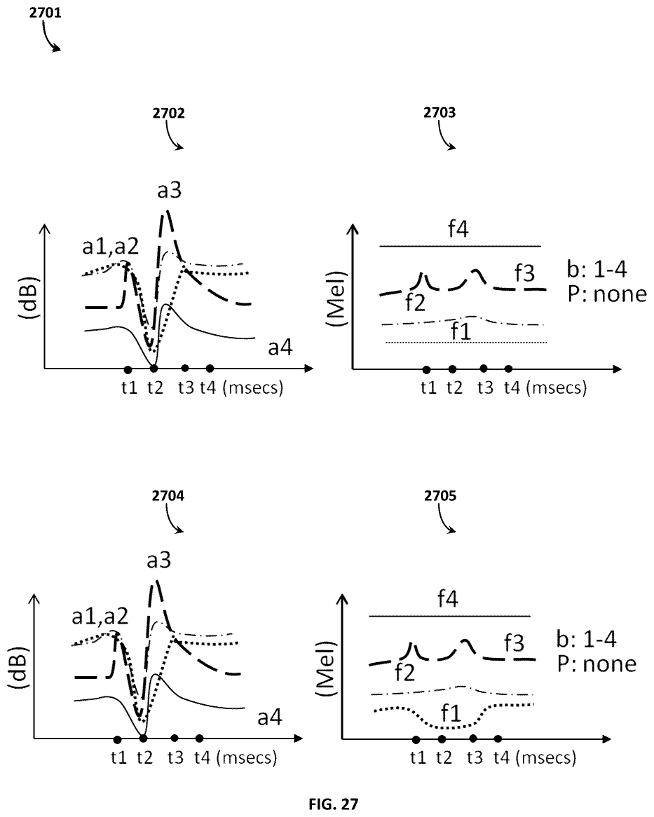

FIG. 28: EMBODIMENTS OF SYMBOLS FOR AA-AY-AA & AA-AW-AA;

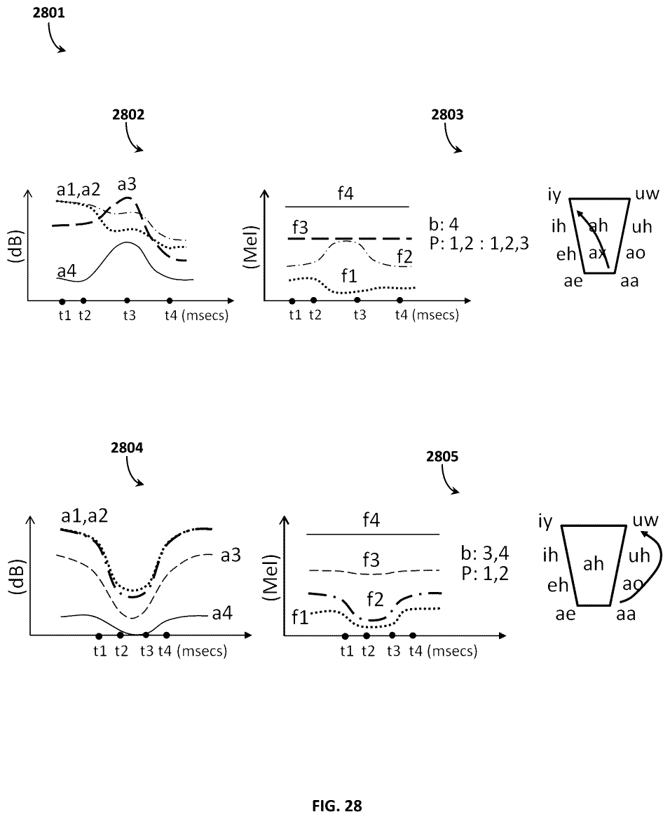

FIG. 29: EMBODIMENTS OF SYMBOLS FOR RETROFLEX CONSONANTS;

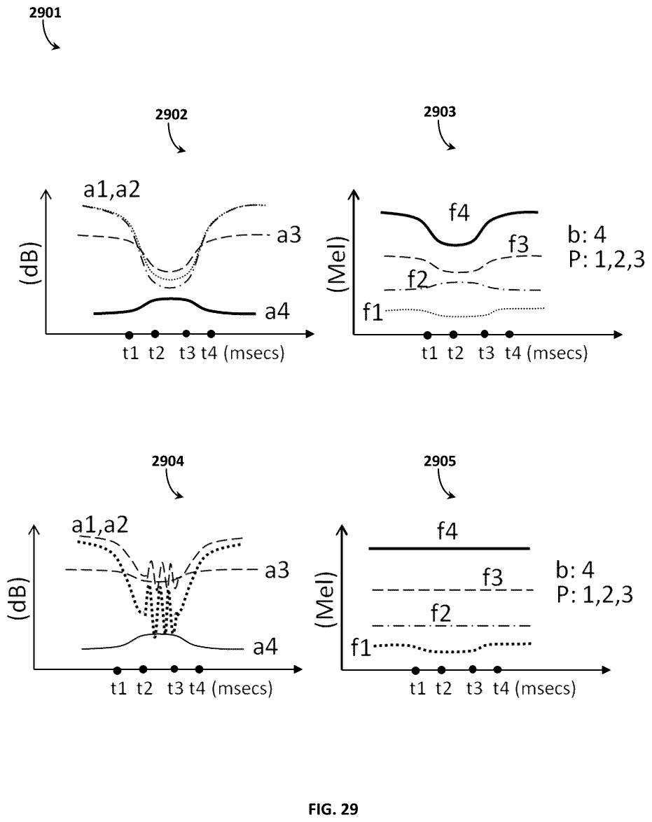

FIG. 30: EXAMPLES OF DIFFERENT CONTEXT & RESONANCES;

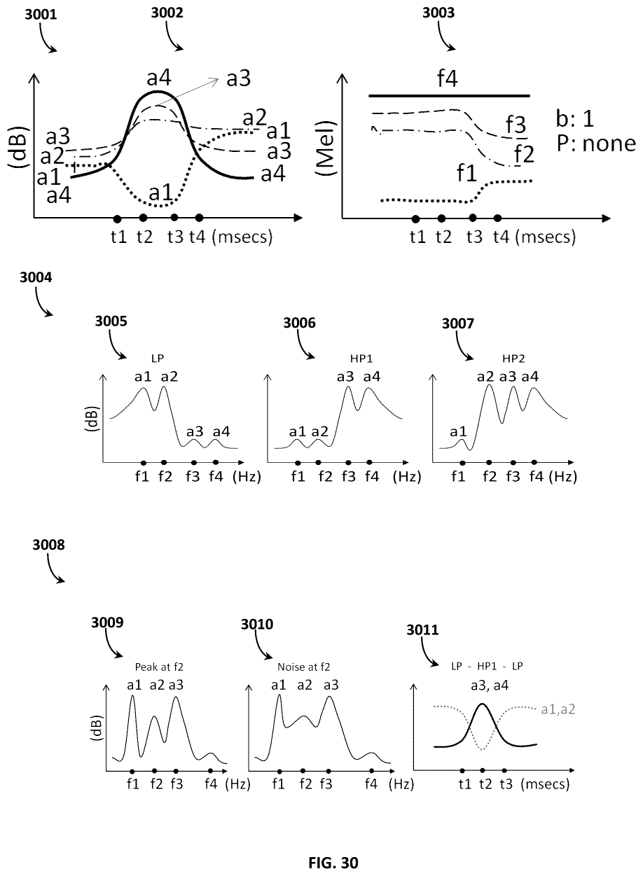

FIG. 31: REFERENCES TO SCIENTIFIC PAPERS 3101 TO 3113;

FIG. 32: REFERENCES TO SCIENTIFIC PAPERS 3201 TO 3214;

FIG. 33: REFERENCES TO SCIENTIFIC PAPERS 3301 TO 3314;

FIG. 34: REFERENCES TO SCIENTIFIC PAPERS 3401 TO 3413;

FIG. 35: EQUATIONS FOR SIGNAL AND MODULATION VECTOR;

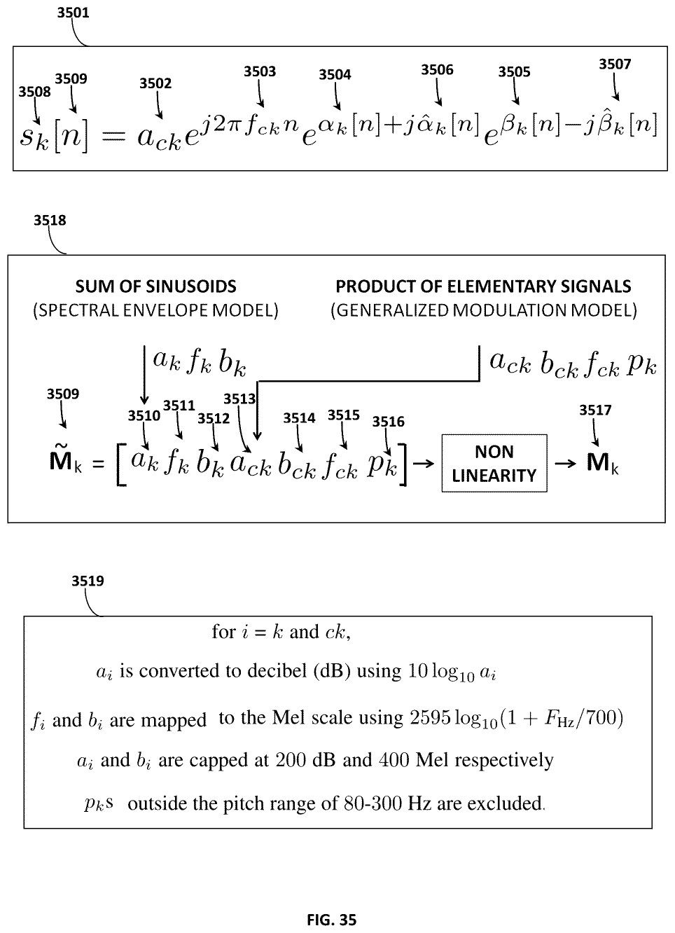

FIG. 36: EQUATIONS FOR TFB'S DYNAMIC TRACKING FILTER;

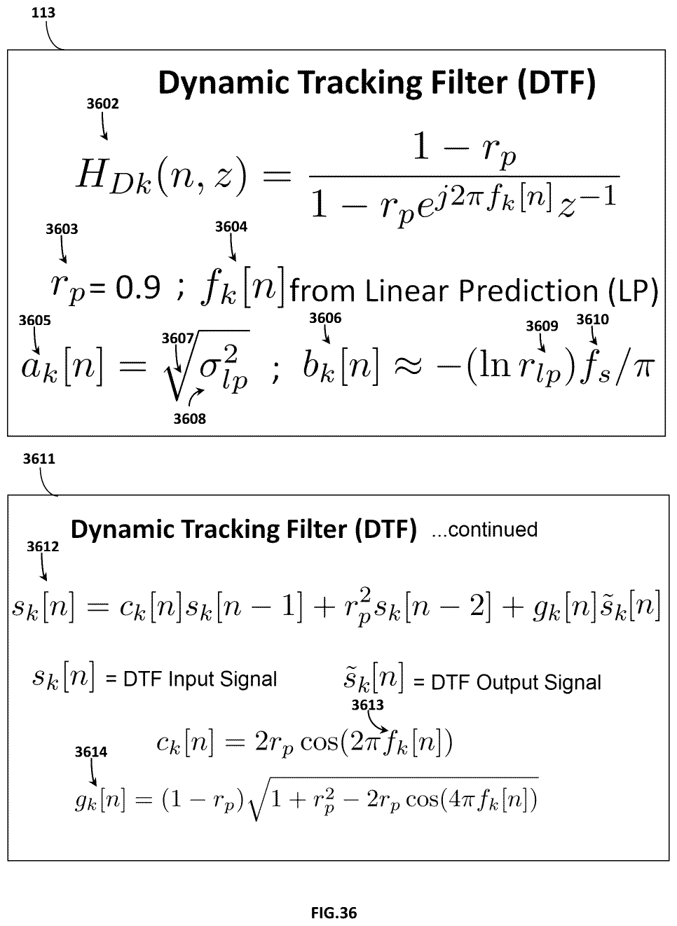

FIG. 37: EQUATIONS FOR TFB'S NON-LINEAR MASKER;

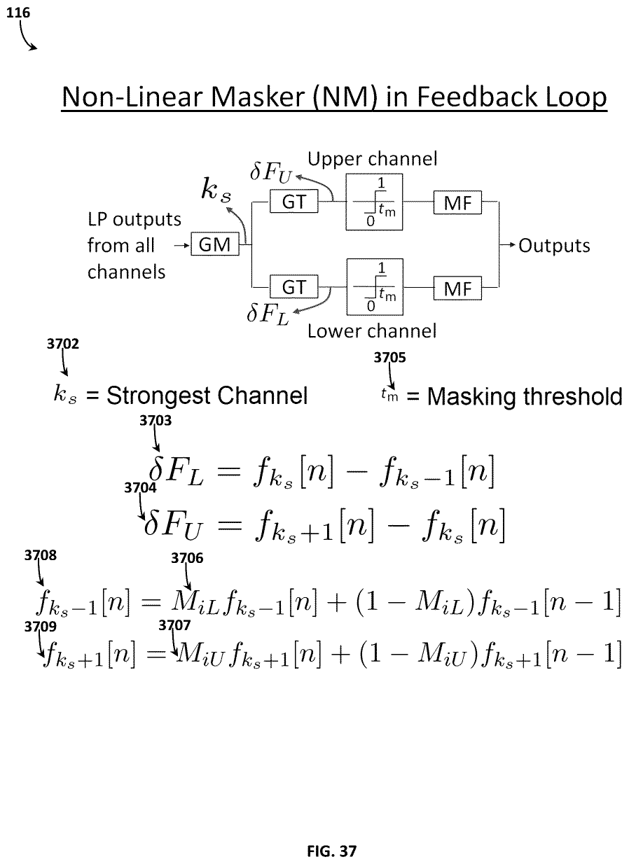

FIG. 38: EQUATIONS FOR TFB'S ALL ZERO FILTER;

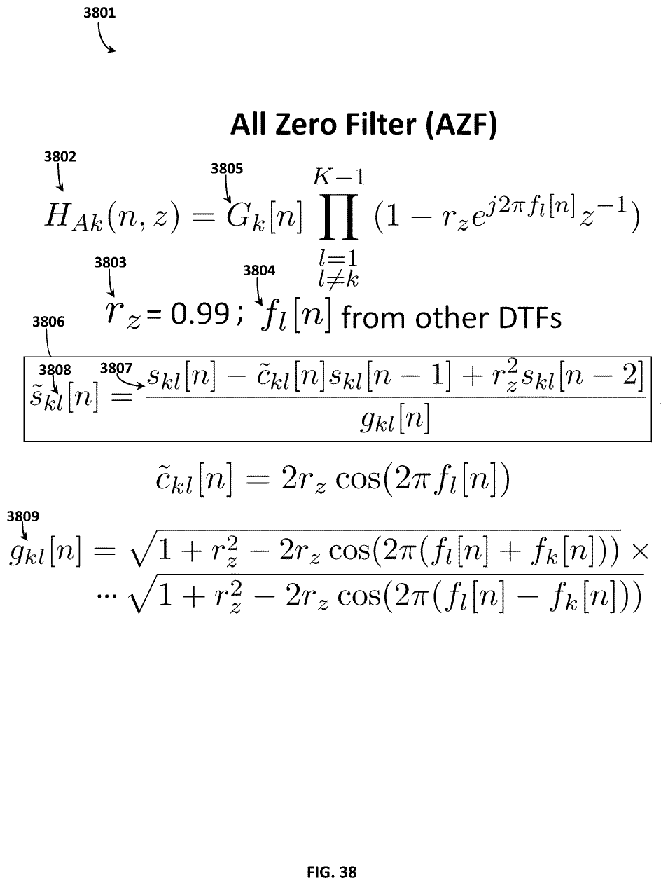

FIG. 39: EQUATIONS FOR TFB'S MODULATION FEATURE ESTIMATOR;

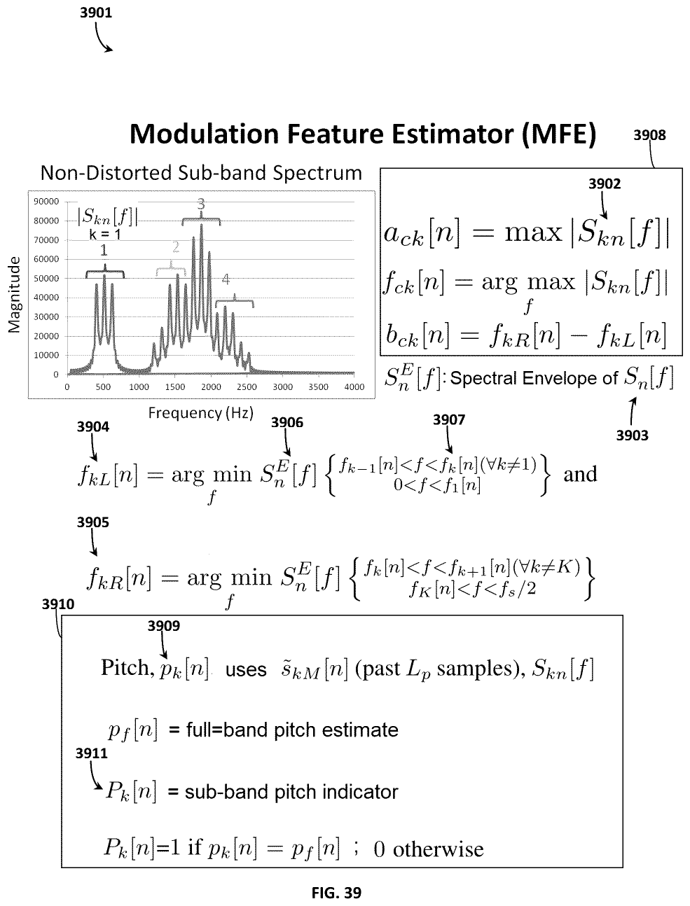

FIG. 40: EQUATIONS FOR MODULATION VECTOR NOTATIONS;

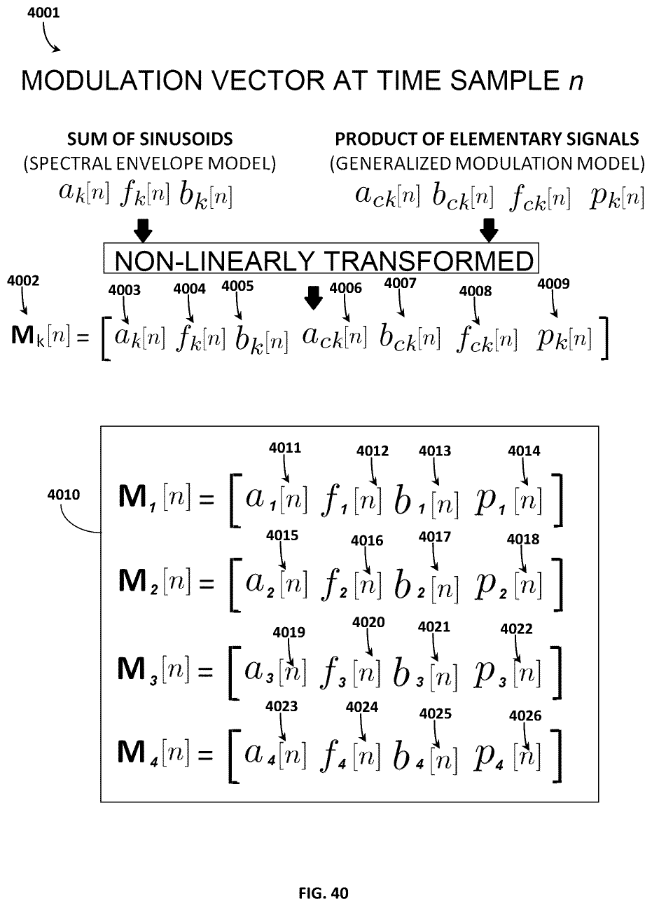

FIG. 41: ONE EMBODIMENT OF ACOUSTIC CODE FOR IY-SH-IY;

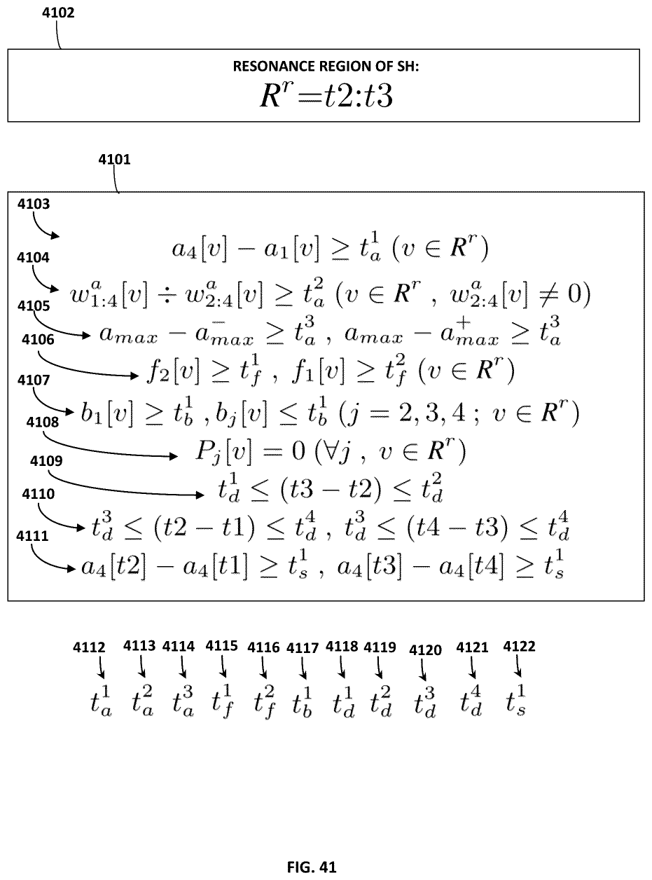

FIG. 42: NOTATIONS & PARAMETERS FOR TFB ANALYSIS;

FIG. 43: ONE EMBODIMENT OF ACOUSTIC CODE FOR AA-SH-AA;

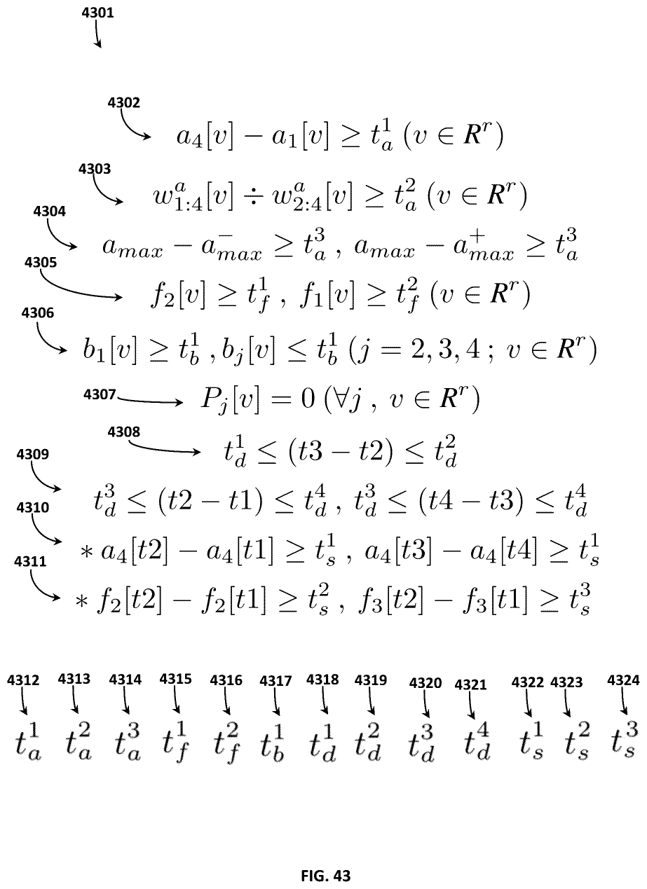

FIG. 44: ONE EMBODIMENT OF ACOUSTIC CODE FOR AA-T-AA;

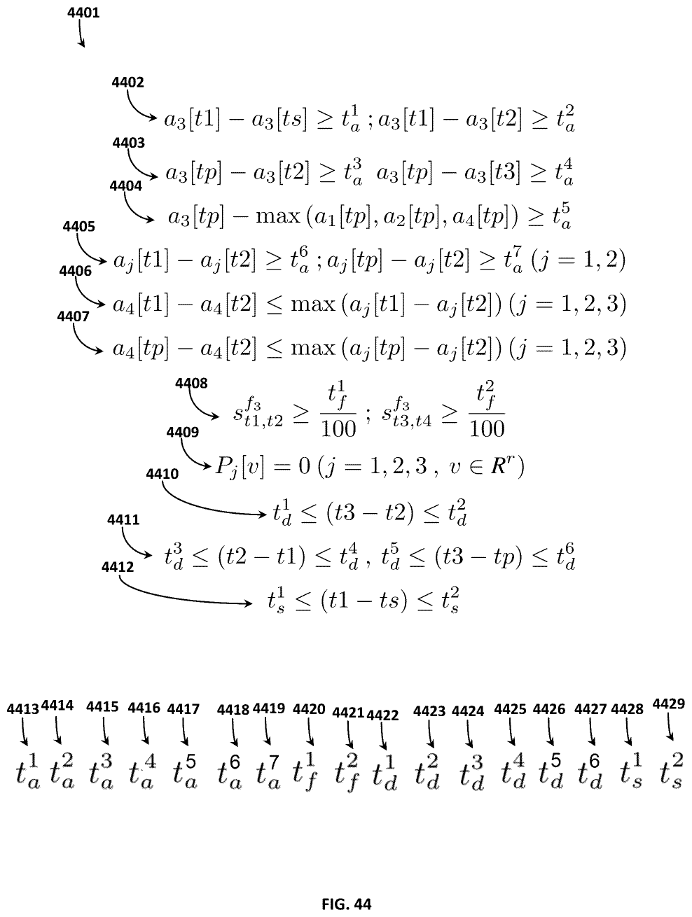

FIG. 45: ONE EMBODIMENT OF ACOUSTIC CODE FOR AA-R-AA;

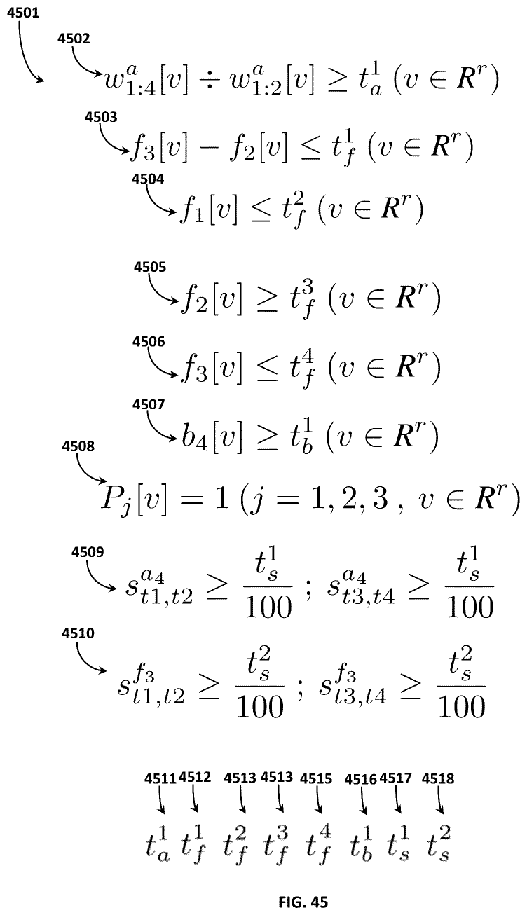

FIG. 46: ONE EMBODIMENT OF ACOUSTIC CODE FOR AA-UW-AA;

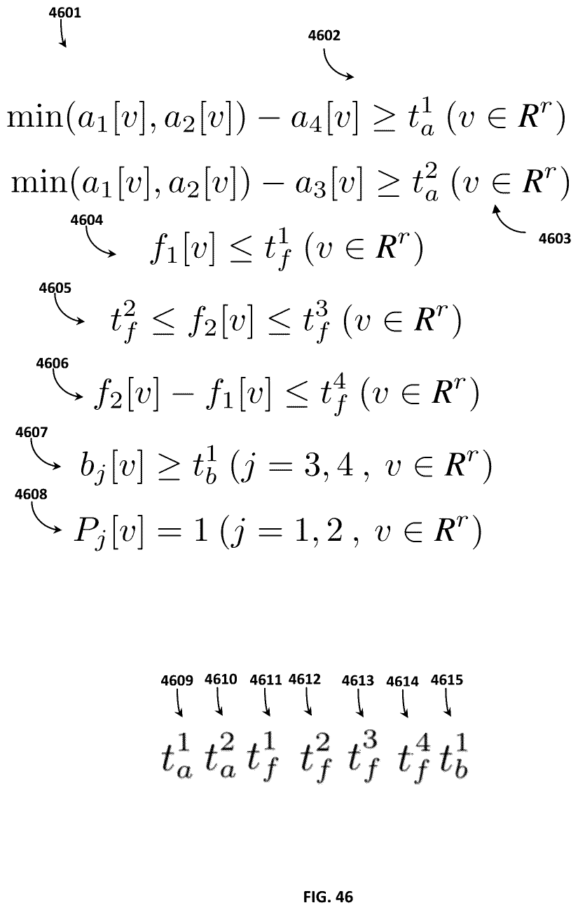

FIG. 47: ONE EMBODIMENT OF THE CONFIDENCE METRIC AND EMBODIMENTS OF ACOUSTIC CODES FOR AA AND AA-ZH-AA;

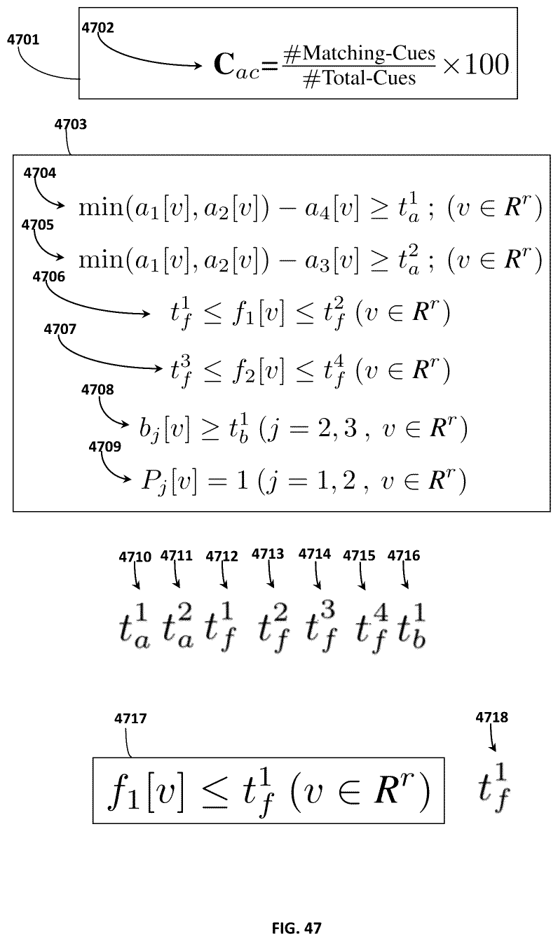

FIG. 48: ONE EMBODIMENT OF ACOUSTIC CODE FOR AA-CH-AA;

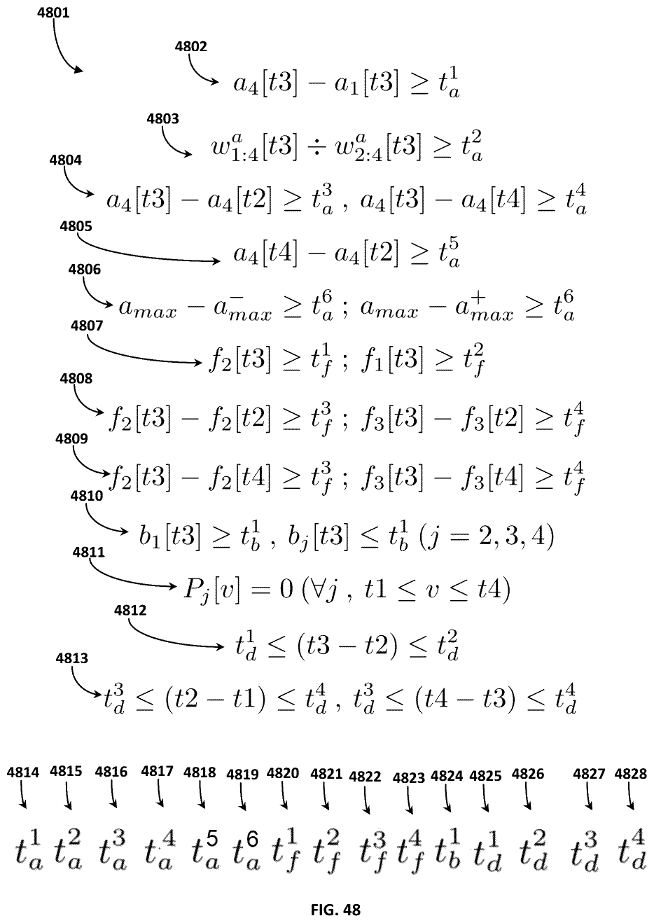

FIG. 49: EMBODIMENTS OF ACOUSTIC CODES FOR AA-JH-AA, AA-S-AA, AND AA-Z-AA;

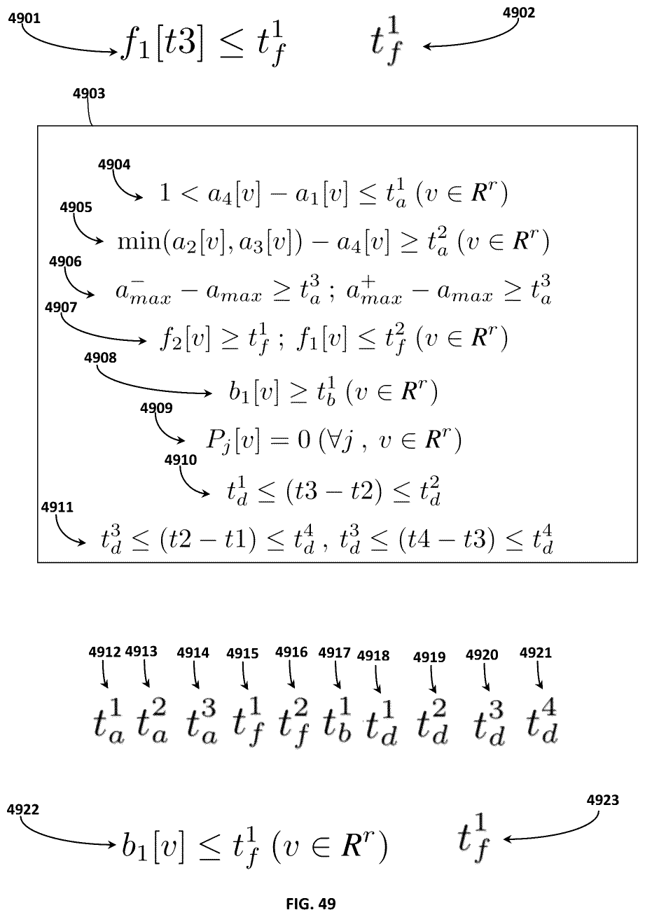

FIG. 50: ONE EMBODIMENT OF ACOUSTIC CODE FOR AA-F-AA;

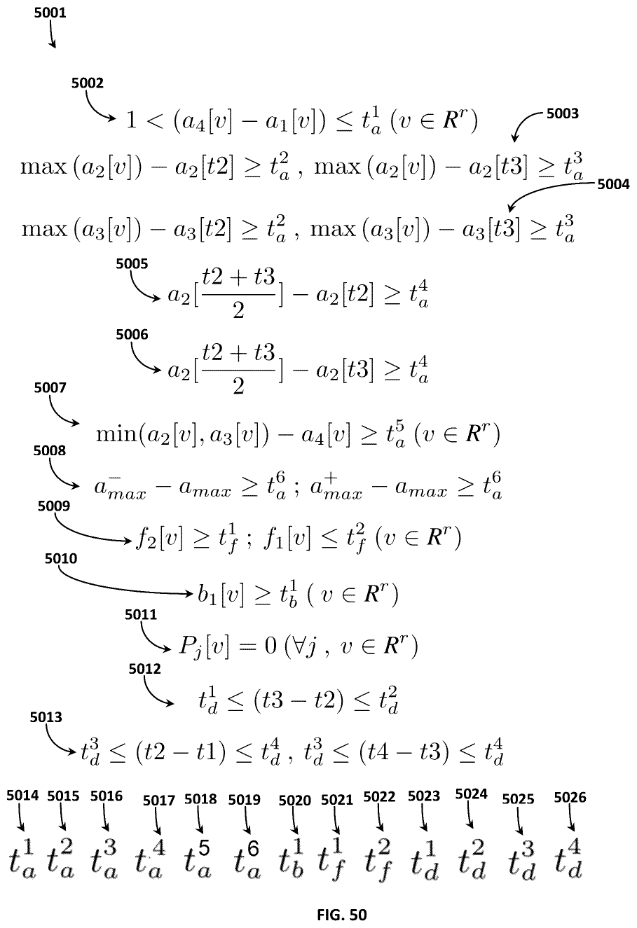

FIG. 51: EMBODIMENTS OF ACOUSTIC CODES FOR AA-V-AA AND AA-H-AA;

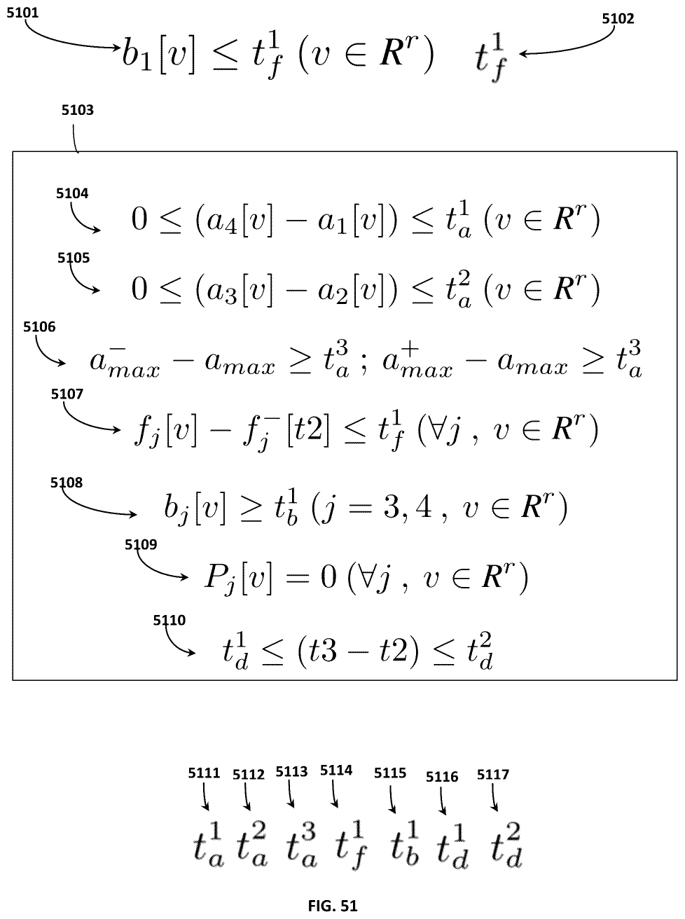

FIG. 52: ONE EMBODIMENT OF ACOUSTIC CODE FOR AA-IY-AA;

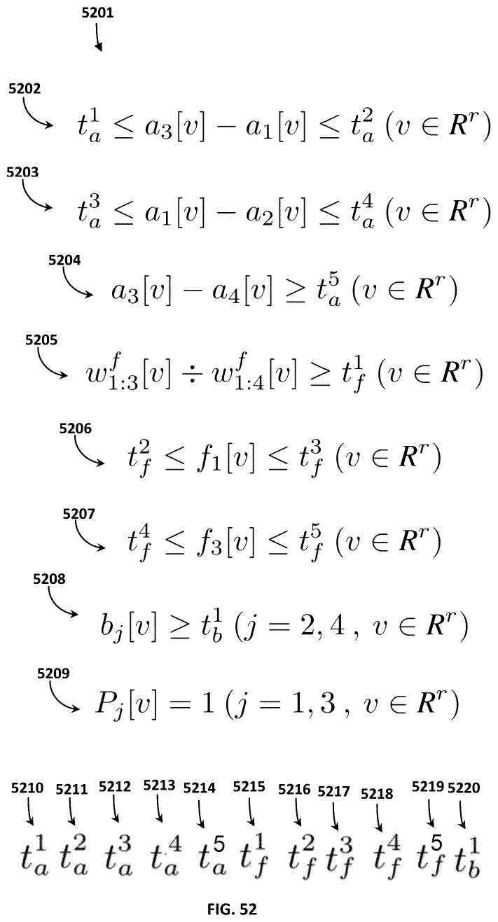

FIG. 53: ONE EMBODIMENT OF ACOUSTIC CODE FOR AA-Y-AA;

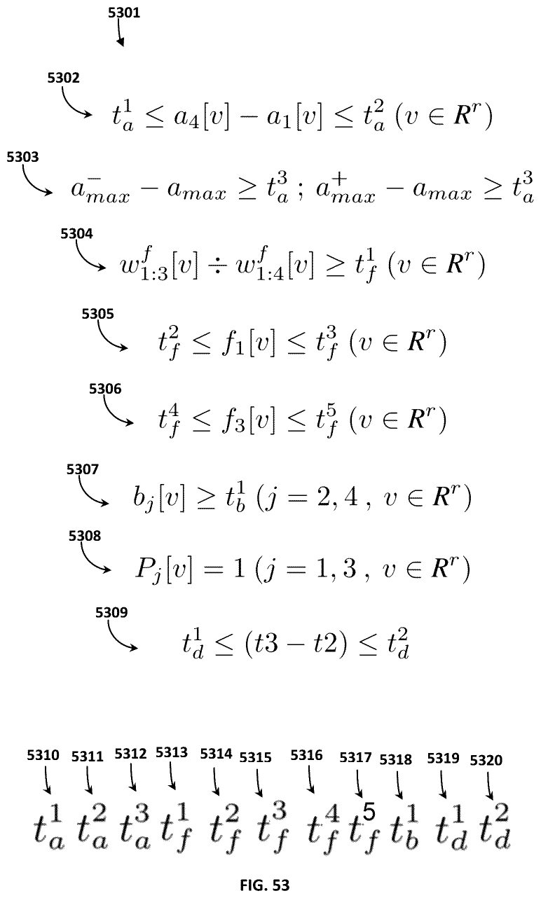

FIG. 54: ONE EMBODIMENT OF ACOUSTIC CODE FOR AA-W-AA;

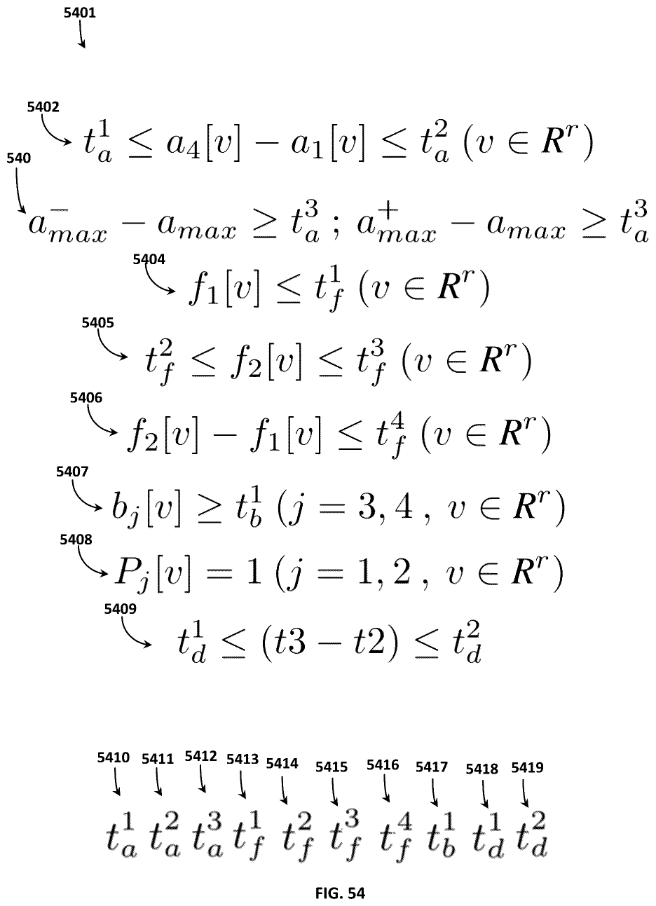

FIG. 55: ONE EMBODIMENT OF ACOUSTIC CODE FOR AA-M-AA;

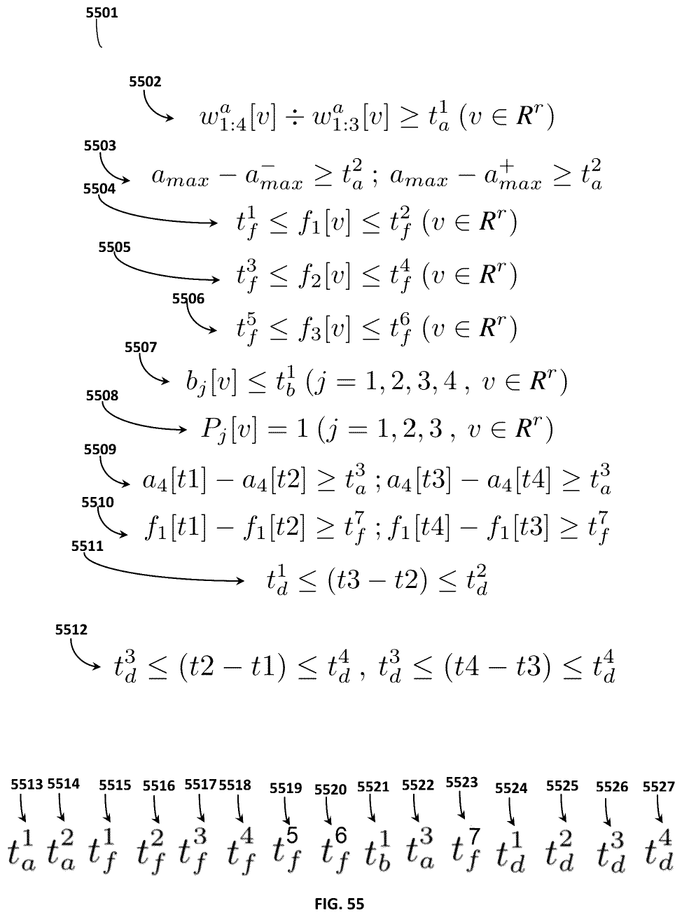

FIG. 56: ONE EMBODIMENT OF ACOUSTIC CODE FOR AA-N-AA;

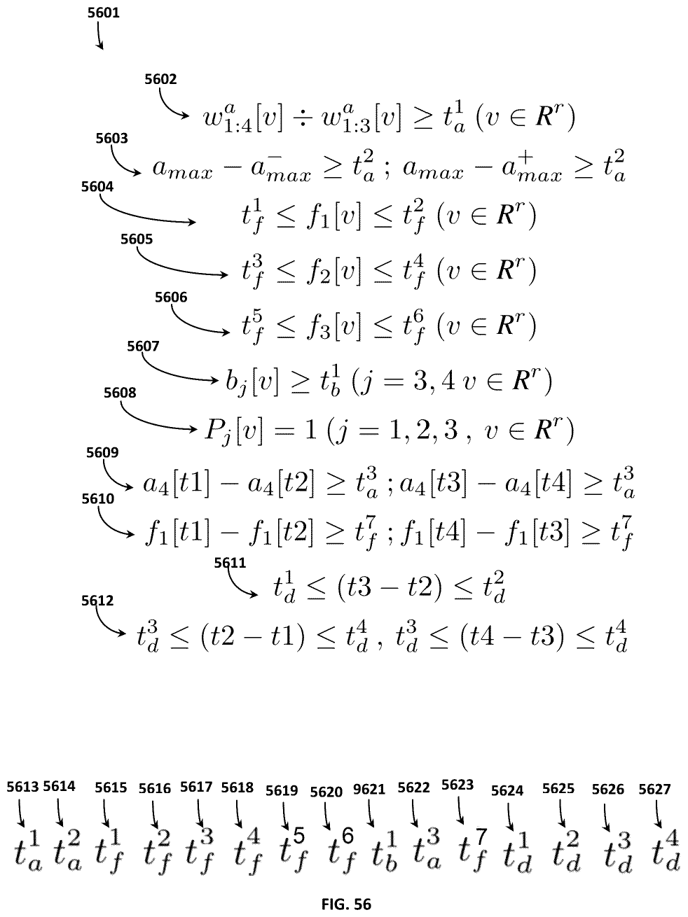

FIG. 57: ONE EMBODIMENT OF ACOUSTIC CODE FOR AA-L-AA;

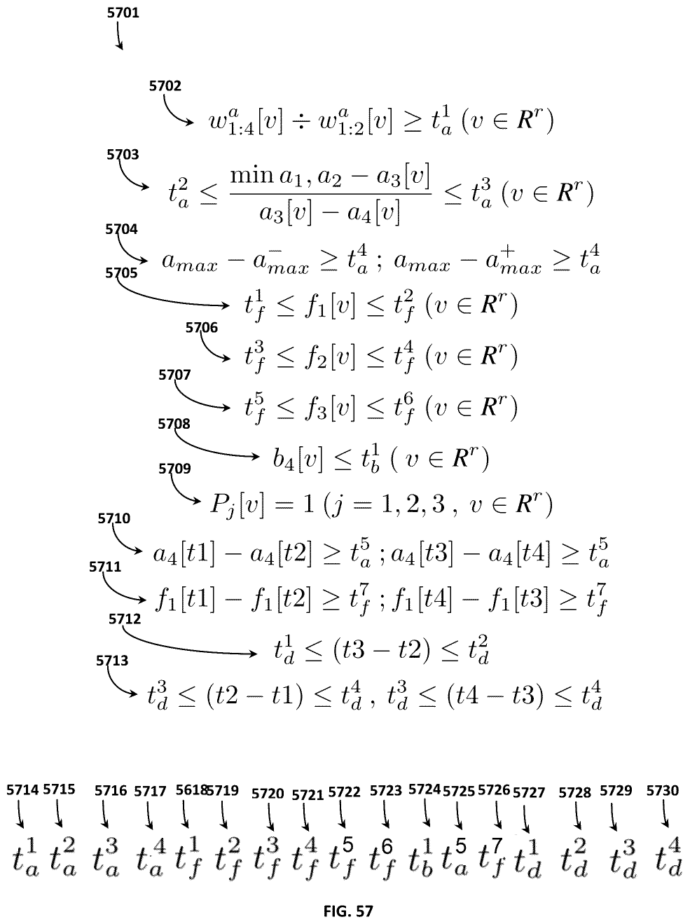

FIG. 58: EMBODIMENTS OF ACOUSTIC CODES FOR AA-D-AA, AA-P-AA, AA-B-AA, AA-TH-AA, AND AA-DH-AA;

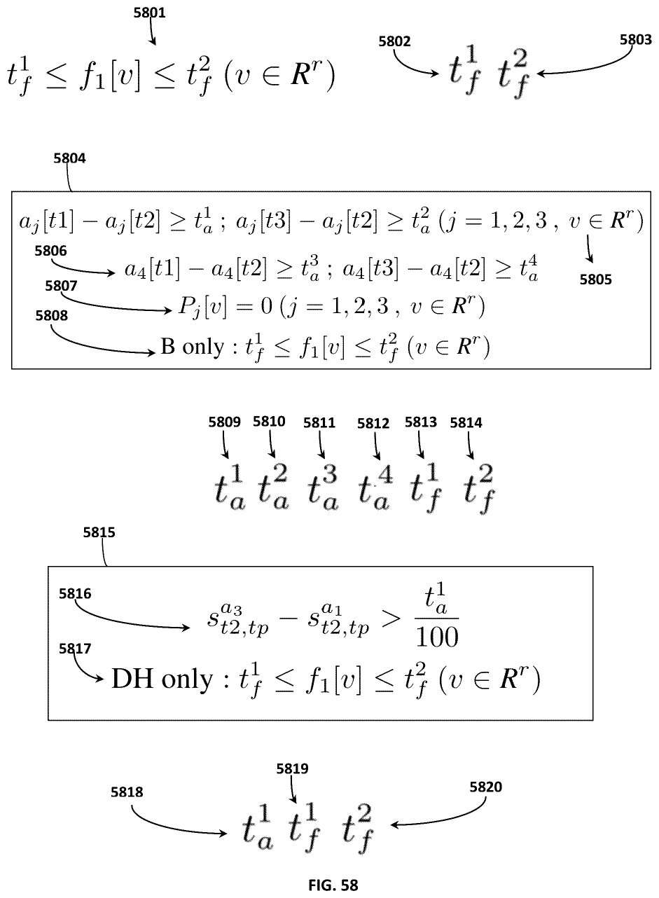

FIG. 59: EMBODIMENTS OF ACOUSTIC CODES FOR AA-K-AA AND AA-G-AA;

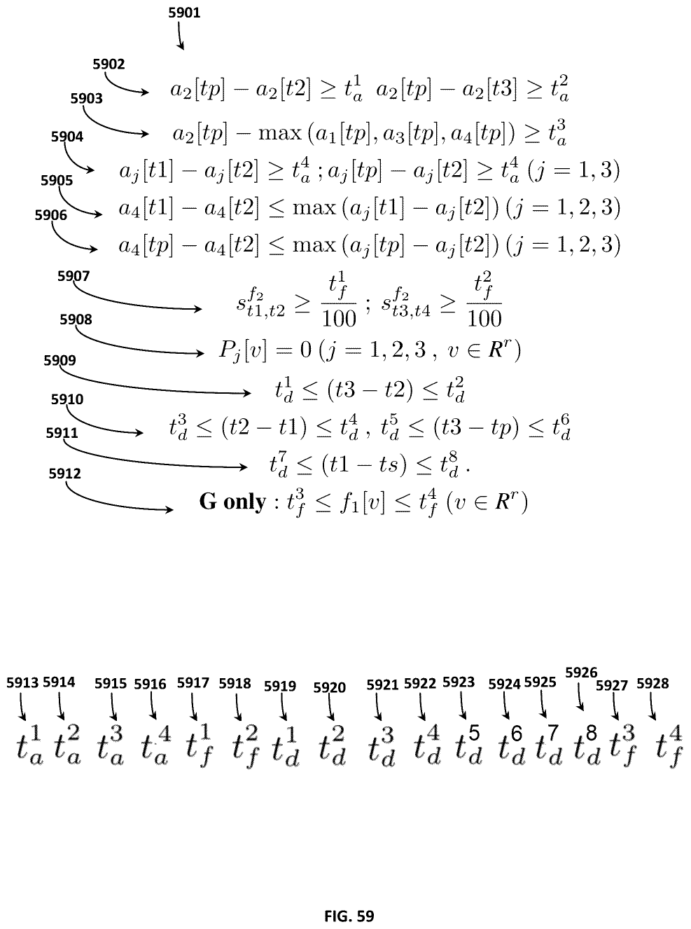

FIG. 60: ONE EMBODIMENT OF ACOUSTIC CODE FOR DIPHTHONG AY;

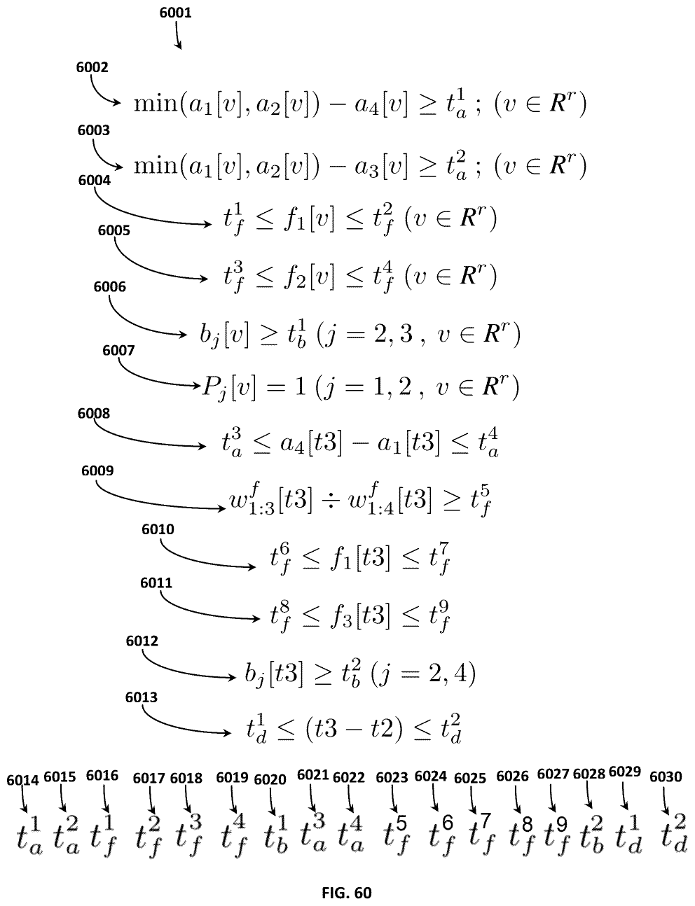

FIG. 61: ONE EMBODIMENT OF ACOUSTIC CODE FOR DIPHTHONG AW;

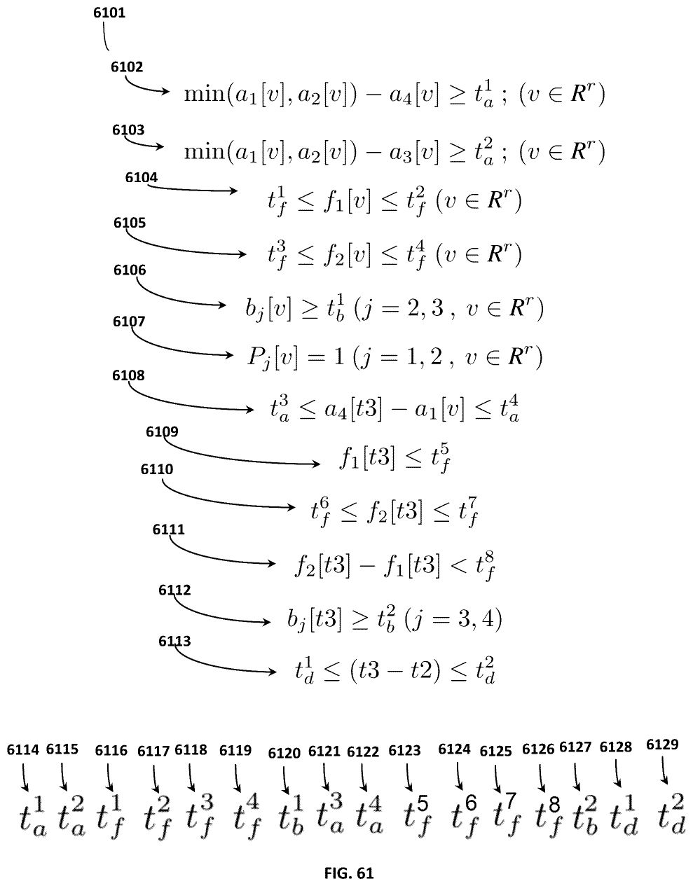

FIG. 62: ONE EMBODIMENT OF ACOUSTIC CODE FOR A DIFFERENT FORM OF AA-R-AA;

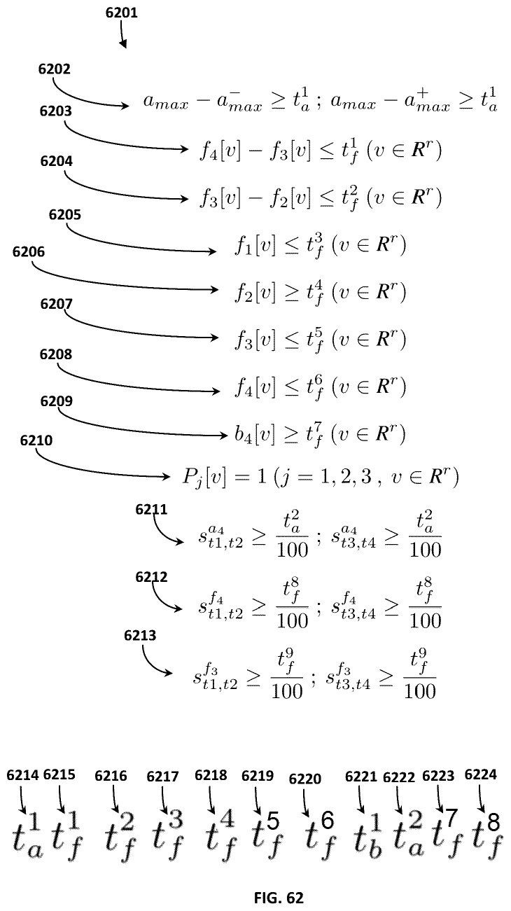

FIG. 63: ONE EMBODIMENT OF ACOUSTIC CODE FOR YET ANOTHER DIFFERENT FORM OF AA-R-AA;

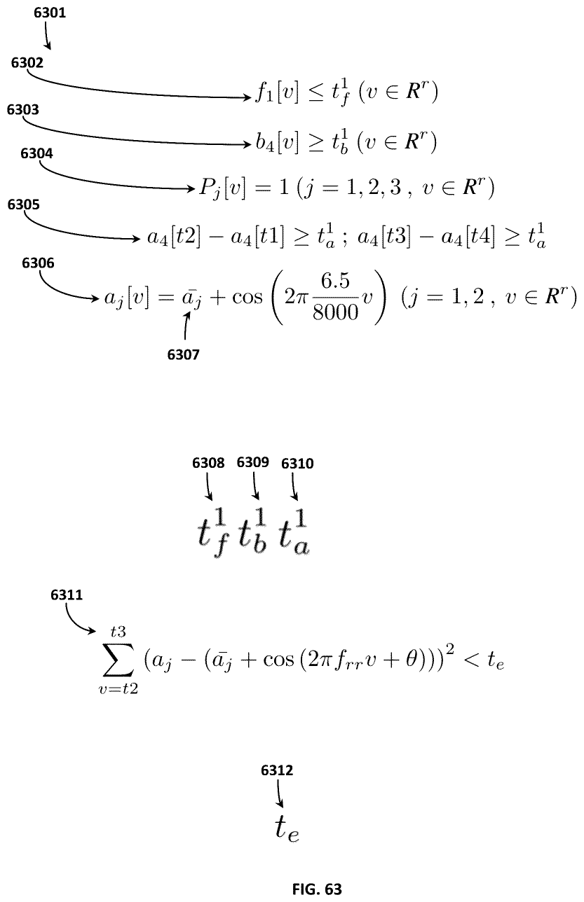

FIG. 64: RELATIONSHIP BETWEEN MODULATION VECTOR AND SPECTRAL ENVELOPE.

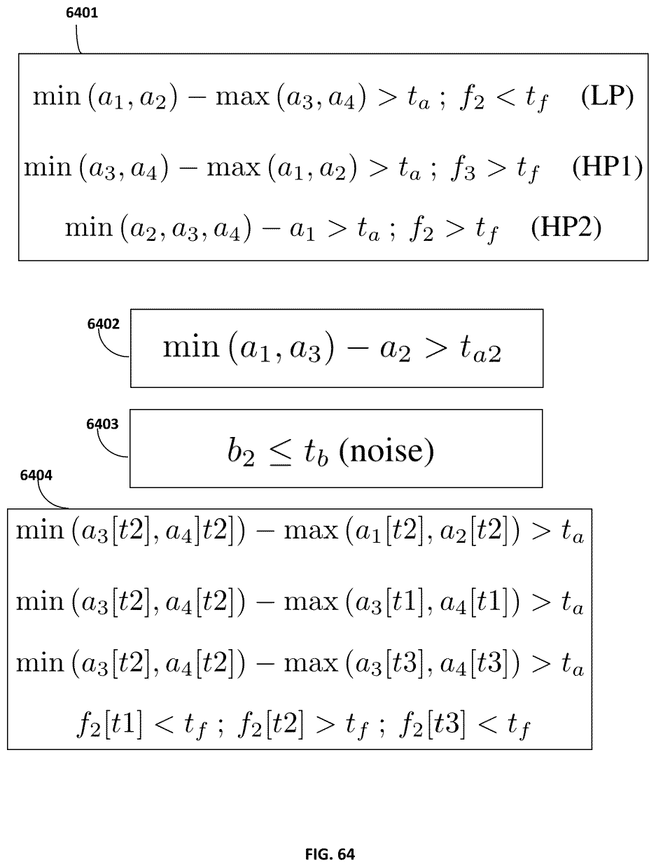

### DETAILED DESCRIPTION OF THE PREFERRED EMBODIMENT

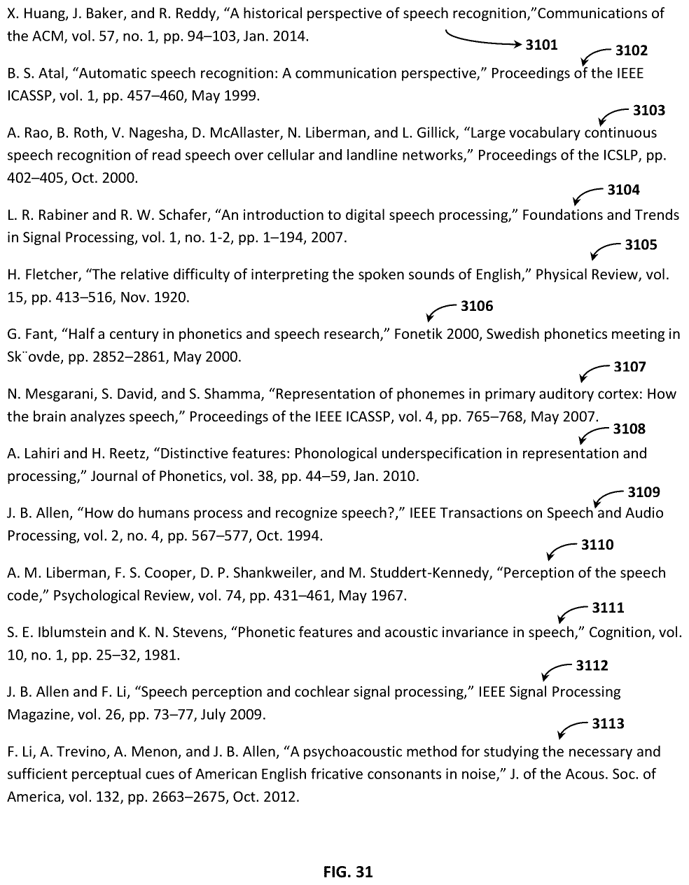

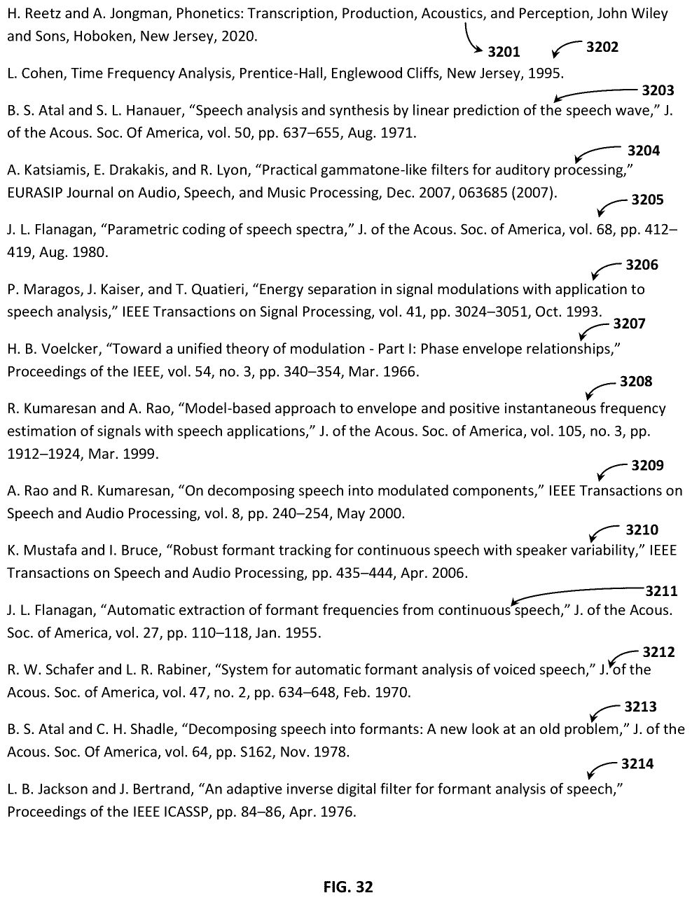

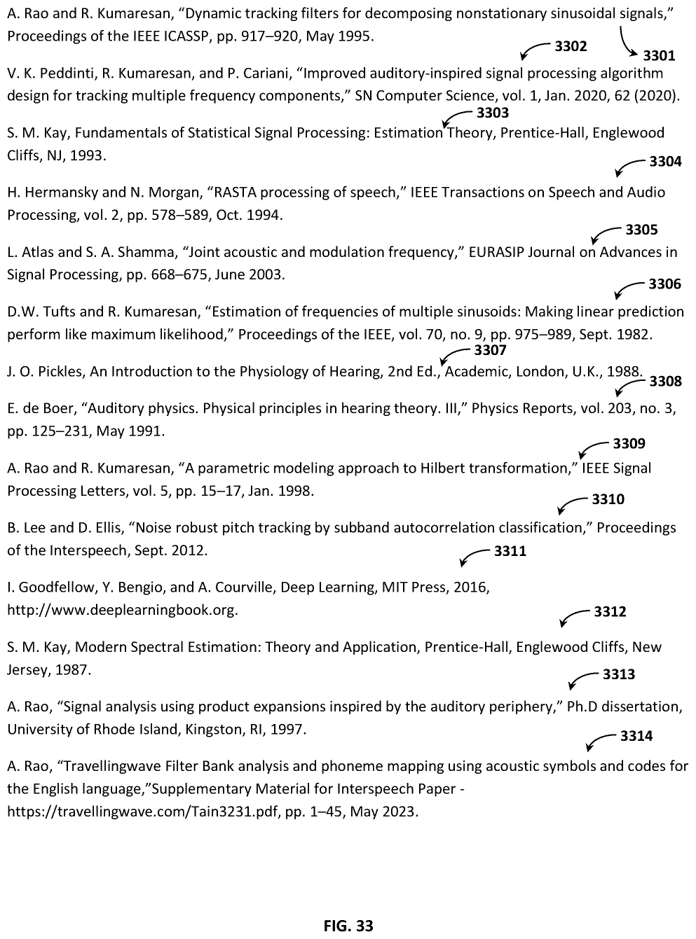

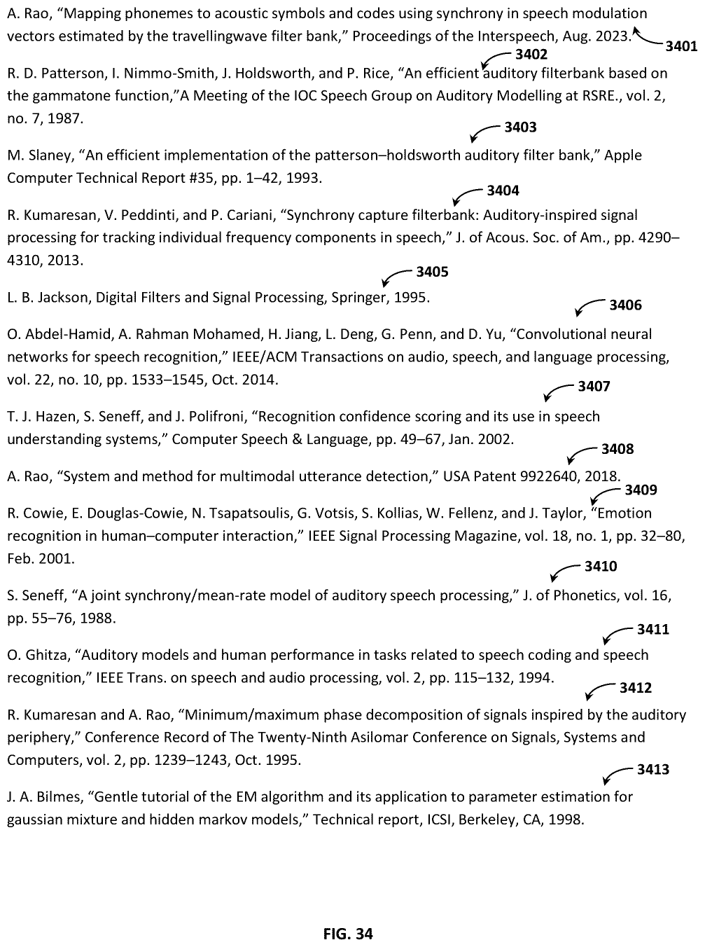

This invention introduces three new concepts for acoustic-phonetic mapping, which are significant advancements to all previously published methods; scientific references to many of which are listed in FIGS. 31, 32, 33, and 34.

The first concept, called modulation vector, is a hybrid representation for speech resonances that combines features from sinusoidal models (references 3205, 3206) and a generalized modulation model (references 3207, 3208, 3209). The second is an adaptive filter bank that improves upon the Rao-Kumaresan algorithm (reference 3209); which was modified by Mustafa and Bruce (in reference 3210). Specifically, it addresses problems in references 3209 and 3210, associated with complex-valued signals, frequency tracking errors, and filter instability. Additionally, it employs resonance localization to track modulation vectors in speech; instead of tracking formants as in references 3211, 3212, 3213, 3214, 3210, or modulated components (envelope and positive instantaneous frequency) as in references 3208 and 3209, or individual frequency components as in references 3301 and 3302. Finally, the third concept utilizes synchrony in modulation vectors, within and across sub-bands, for mapping phonemes to acoustic symbols and codes.

In the remaining sections, modulation vector is defined in section 1, the adaptive filter bank is described in section 2, phoneme mapping using synchrony is derived in section 3, simulation results are presented in section 4, further analysis and more examples are presented in section 5, unique acoustic-phonetic mappings for English language phonemes are provided in section 6, phonemes with different left and right context are considered in section 7, relationship between modulation vector and spectral envelope is addressed in section 8, using bandwidth estimates to detect mismatch between signal and TFB is provided in section 9; and discussions are in section 10.

### 1. Modulation Vector

In references 3208 and 3209, the k-th resonance in a speech signal, s[n], was expressed using the product of elementary signals (reference 3207) as in equation 3501, where 3509 is the time sample [n], 3502 is the carrier amplitude, and 3503 is the carrier frequency. The details in modulations around 3503 are denoted by 3504 and 3505; hat stands for Hilbert transform (reference 3303). Using equation 3501, along with speech representations based on sum of sine waves (references 3205, 3206), a modulation vector is now defined as in equation 3509, where 3510, 3511, and 3512 denote amplitude, frequency, and bandwidth parameters, which model the spectral envelope of the signal 3508; 3514 is the bandwidth around 3515; and 3516 is the pitch of the signal 3508. The relationship between 3511 and 3515 may be understood from reference 3208; parameters modeling 3504 and 3505 may be added using modulation spectrum (references 3304, 3305) and sub-space (reference 3306) related concepts. Next, the elements of 3509 are transformed, so that their scales and regions of interest, match the ones used in auditory systems (references 3104, 3112, 3307). This is done as shown in 3519.

### 2. Travellingwave Filter Bank (TFB)

The TFB algorithm estimates and tracks the modulation vector 104, by drawing inspiration from the travellingwave on the basilar membrane in the human car's cochlea (references 3307, 3308). Its ability to separate individual resonances, along with its hybrid representation, makes TFB superior to the spectrogram, for speech analysis.

Each channel 110 of TFB (101) consists of a Dynamic Tracking Filter (DTF) 113, whose feed-back loop includes a first-order Linear Prediction (LP) 117 estimator (reference 3303) and a Non-linear Masker (NM) 116. The DTF is preceded by an All Zero Filter (AZF) 112, and coupled to a Modulation Feature Estimator (MFE) 111. A non-linear encoder (NE) 114 finally outputs 104 as per section 1. The basic idea behind TFB is that each channel's AZF-DTF 112-113 combination tracks the localized resonance frequency of the input speech signal 103, and the MFE 111 estimates (and implicitly tracks) the modulations characterizing its associated sub-band.

### 2.1 Dynamic Tracking Filter

The DTF 113 proposed is advancement to the one in reference 3209. It is an adaptive single-resonance filter with a transfer function given by equation 3602 in DTF 113, where k is the channel number; n is the sample number; and 3603 is the pole-radius. 3604 is estimated by LP 117 (using its pole-angle) based on the past L samples of DTF's output. The improvements made are described next.

2.1.1 Estimation of 3605, 3606, and Constant-Q Option: 3605 is set to be 3607, where 3608 is the LP error-variance. The value of 3606 is approximated using the LP pole-radius 3609 (reference 3209); where 3610 denotes the sampling frequency. Further, L can be made smaller, as k increases, to maintain a constant-Q (reference 3104) window. This will enable rapid and finer analysis at higher frequencies.

### 2.1.2 Implementation for Real-Valued Signals:

The DTF is implemented using the difference function equation 3612 shown in 3611, where the DTF's gain at the frequency 3613 is set to unity by 3614. This avoids computation of the analytic signal (reference 3202), thereby overcoming Hilbert transform related problems (reference 3309).

### 2.1.3 Non-Linear Masker:

The LP outputs (122 from all channels) are analyzed by NM 121 as follows: Get Masker (GM) 130 sorts all 3613 in 3611 (for all k) and gets the strongest unmasked channel 3702. Then Get Thresholds (GTs) 131 and 136 compute 3703 and 3704 for the lower 125 and upper 123 channels respectively. Next, by comparing 3703 and 3704 to a masking threshold 3705, masking indicators, 3706 and 3707 are computed by 132 and 135; set to be 0 (if 3703 or 3704 are less than 3705) or 1 (if 3703 or 3704 are greater than 3705). Finally, the Masking Filters (MFs) 133 and 134 use equations 3708 and 3709, to yield the NM 116 output 124.

This process is repeated until there are no unmasked channels. NM eliminates errors due to switching of frequency tracks. Also, it weights the frequency estimates at n-l and n, using the estimated masking thresholds. This ensures stability of the overall filter bank, when the DTF frequencies come close to each other. It is different from the one in reference 3210 that sets a limit to the maximum allowable frequency spacing between DTFs, which results in tracking errors.

### 2.2 all Zero Filter

The transfer function for the k-th channel AZF 112 is given by (reference 3209) equation 3802, where 3803 is the radius of the AZF's zero, 3804 is the frequency of its zero-location (obtained from other DTFs), and 3805 normalizes the k-th DTF's gain using the cascade gains 3809. The improvements made to AZF include stability (due to NM 116) and ability to handle real-valued signals. The latter results from AZF's design using a cascade of K−1 filters with the I-th cascade implemented using equation 3806, where 3807 is the input to the I-th cascade (for k=1, 3807 is the speech signal input 103 to the TFB), and 3808 is the output (same as 3807 for l=K−1). The normalizing gain factor 3809 is ensured to be greater than 0.

### 2.3 Modulation Feature Estimator

The k-th MFE 111 derives a non-distorted sub-band spectrum 3902 by utilizing the spectrum 3903 of the past Lp samples of s[n] 103 (computed only once for all k, using the Fourier Transform (reference 3104), along with left and right frequency band-edges, 3904 and 3905 respectively; where 3906 is the spectral envelope (references 3104, 3303) of 3903. Since 3907 is being tracked, this results in an implicit tracking of 3902. Using this, the modulation features are then estimated by equations shown in 3908.

Pitch 3909 is computed using 3902, the past Lp samples of the M-th cascade signal (substituting M in place of/in 3808), and a hybrid of known techniques (reference 3104). Finally, sub-band pitch indicators 3911 are estimated, using 3909 and a full-band pitch estimate, as shown in 3910. As will be seen in section 3, these sub-band pitch indicators (3911) yield useful cues; not provided by existing methods that group non-resonance sub-band pitches to yield one global pitch (reference 3310).

### 3. Modulation Synchrony

Based on several observations of the modulation vector 4002, using mixed language, gender, and age speakers, it is clear that: the simultaneous evolution of the elements of 4002 (i.e. their synchrony), within and across channels, trace symbols that map phonemes. This “modulation synchrony” is now demonstrated using the fricative consonant, SH, having the vowel IY as its context.

For ease of explanation, and since traces of 4004 and 4008 are similar for IY-SH-IY, let us restrict 4002 to include only 4003, 4004, 4005, and 4009; as shown by 4011:4026 in 4010. FIG. 201 displays the acoustic symbol that has been observed for IY-SH-IY. Let 4102 denote SH's resonance region. The details of cues in FIGS. 202 and 203 are then as follows.

For resonance: a4 exceeds a1 by at least 19 dB; the maximum range of all amplitudes (a1, a2, a3, and a4) is at least 3 dB greater than the maximum range of a2, a3, and a4; SH's peak amplitude is greater than those of its adjoining IYs; f2 and f1 are above 1500 Mel and 250 Mel respectively; only b1 is above 125 Mel (b2, b3, and b4 are below 125 Mel); all pitch indicators (p1, p2, p3, and p4) are absent for SH; and duration of 4102 is between 30 and 500 msecs. And for transition: durations (t1: t2 and 13:14) are between 10 and 100 msecs, and the rise and drops of a4 are greater than 5 dB. These (acoustic) cues may be expressed as shown in 4101; using notation 4202 defined in 4201, and notations 4204, 4205, 4206 defined in 4203; the thresholds shown in 4207 (same as 4112:4122) can be estimated using standard statistical (reference 3303) or deep learning (reference 3311) techniques. Earlier studies (reference 3201) that characterize SH by dominant high frequency energy, relative amplitude, and noise duration, have reported only cues that are similar to equations 4105, 4106, and 4109 respectively.

The set of cues in equations 4103:4111 form the acoustic code for IY-SH-IY. Equations 4103 and 4104 that correspond to predominant features of the symbol in FIG. 201, which are necessary to characterize the phoneme, are called the main cues; 4208 and 4209 are called main cue-features.

### 4. Simulations

First, results of analyzing an utterance corresponding to IY-SH-IY, spoken by a male speaker, using a Motorola Z2 Force smart-phone, are presented. TFB parameters were set as shown in 4210.

For this example, the spectrogram that is widely used for acoustic-phonetic mapping (reference 3201), and outputs of the Mel Filter Bank (MFB), which is the de facto standard for speech recognition feature extraction (references 3104, 3101), are shown in 301 and 302 respectively. Apart from high frequency energy, found in many phonemes, they fail to yield other cues, specific to SH.

Other problems associated with them include: a) peak-picking the spectrogram or choosing the right MFB channels, to track resonances, is not trivial (references 3211, 3212, 3213, 3214), b) any chosen MFB filter's center frequency, may not line up with the signal's resonance, resulting in frequency estimation errors, and c) MFB's triangular weighted averaging could bias estimates of cues based on energies—e.g., energy difference between the two “manually selected” channels (1 and 10), whose center frequencies are close to 1st and 4th formant locations, is only approximately 20 dB, as opposed to the true value of approximately 36 dB (computed manually).

In contrast, FIGS. 303:306 display an entire set of cues that form an acoustic symbol, similar to FIG. 201. Specifically, FIG. 303 shows that at peak resonance (540 msecs), value of 1st main cue 4208 is 36 dB; and a2, a3, a4 are grouped together relative to their separation from a1 (value of 2nd main cue 4209 is 18 dB). Further, 4204 value is greater than 4205 and 4206 values, and the transitions of a4 during rise (375:435 msecs) and drop (645:720 msecs) are steep (23 dB and 19 dB respectively). FIG. 304 shows that in the resonance region, value of f2 is greater than 1500 Mel, f1 value is greater than 250 Mel, and b1 is greater than 100 Mel. Also, the values of f2, f3, and f4 are similar to those of their adjoining IYs.

FIG. 305 displays b1, b2, b3, and b4, for this example. Notice that only b1 exhibits deviations during SH's resonance. Further, observe that FIG. 306 shows no harmonic lines (no p1, p2, p3, and p4) for any of SH's resonances, whereas the IY portions of FIG. 306 display pitch lines.

Clearly, the example considered maps to the acoustic code of equations 4103:4111, with the values of thresholds 4112:4122 being 36, 18, 3, 1500, 250, 100, 400, 400, 60, 70, and 19 respectively.

In FIGS. 401 and 402, the average (mu) of main cue-features, sampled at peak resonance, as a function of signal-to-noise ratio (SNR=10 log 10(Ps/sigma2), where Ps is the speech power with silence excluded, and sigma2 is the noise power) is plotted; error-bars indicate-sigma. A comparison of mu-sigma to thresholds, reveals that TFB is robust at SNRs greater than or equal to 8 dB for white noise; at lower SNRs, at least one cue-feature's mu-sigma falls below threshold, and the symbol looses its predominant shape. For factory noise, due to its intermittent bursts, sigma is relatively higher and TFB is robust only for SNRs greater than or equal to 15 dB. Thus, TFB has potential to extract symbols even in noise.

### 5. Further Analysis and More Examples

This section presents a detailed analysis of the TFB algorithm using several examples of synthetic and real-world speech recordings.

### 5.1 TFB and MFB Comparison Using a Synthetic Steady-State Vowel

In this section, the problem with MFB (reference 3104) is first demonstrated by considering a simple example of a signal made up of sine waves that exhibits two resonances. This is then followed by the more complex example of a sinusoidal signal consisting of 4 resonances, whose spectral magnitude resembles the magnitude-spectrum of the vowel sound IY. Using this example, it is shown that TFB is superior to MFB for estimating amplitudes and frequencies characterizing spectral resonances.

Signal with Two Resonances: Consider a signal, s[n], with a spectrum as shown in 502; the signals frequencies were selected such that they exactly match the bin-frequencies of the Discrete Fourier Transform (DFT), used for implementing MFB.

This signal was fed to the MFB algorithm; 10 typical channels with commonly used log-spacing and triangular weighting (reference 3104), were used for processing. The outputs for all these 10 channels are plotted in FIG. 503. Based on this, it is now argued that there are two problems with the MFB, when it is used for estimating the amplitudes and frequencies of s[n]'s resonances.

The first problem is that there is no means to choose the two channels of MFB (out of its 10 channels) such that they are closest to the resonance frequencies, namely 624.9504 Hz and 1625.9418 Hz. This problem gets even worse as the number of resonances in the signal increases; as seen in the second example considered in this section.

The second problem with MFB is its triangular weighted averaging that biases the amplitude estimates. For instance, FIG. 504 shows the amplitude outputs of the two manually selected MFB channels, namely 1 and 5, whose center frequencies exactly line up with s[n]'s resonance locations. Even in this ideal scenario, notice that the amplitudes 32 dB and 29 dB (for channels 5 and 1 respectively) get wrongly estimated as 55 dB and 50 dB respectively. This problem gets worse when a) the resonance frequencies do not match the DFT bin frequencies, and b) when the MFB filter bandwidths get broader at high frequencies.

Signal with Four Resonances (Synthetic Vowel): Now consider a synthetic IY signal, s[n], which has a DFT magnitude as shown in FIG. 602. Clearly, the DFT-Magnitude of s[n] displays 4 resonances, which closely resemble the resonances that typically occur in the spectrum of vowel sound IY. The outputs of all 10 channels of MFB are shown in FIG. 603. Unfortunately, selecting 4 out of these 10 channels is not a trivial task; techniques like spectral peak-picking or parametric model fitting (references 3104, 3312), suffer from severe drawbacks when applied to this problem (reference 3313).

In contrast, notice that the outputs of all channels of the TFB algorithm precisely track the resonance frequencies (shown in FIG. 605) and the amplitudes of those resonances (shown in FIG. 604). It is well-known that resonances in speech signals, called formants, slowly change with time. Obviously, this would pose additional problems for fixed filter bank techniques like MFB. Even formant tracking algorithms proposed in literature (references 3209, 3210, 3211, 3212, 3213, 3214) have had limited success in addressing this problem. However, TFB's adaptive time-frequency filtering, which is specifically designed to handle such non-stationary signals, can easily be applied to such signals, as shown next. Links to TFB source-code and data-sets (to enable reproducibility), are in reference 3314.

### 5.2 Analysis of TFB for More Examples

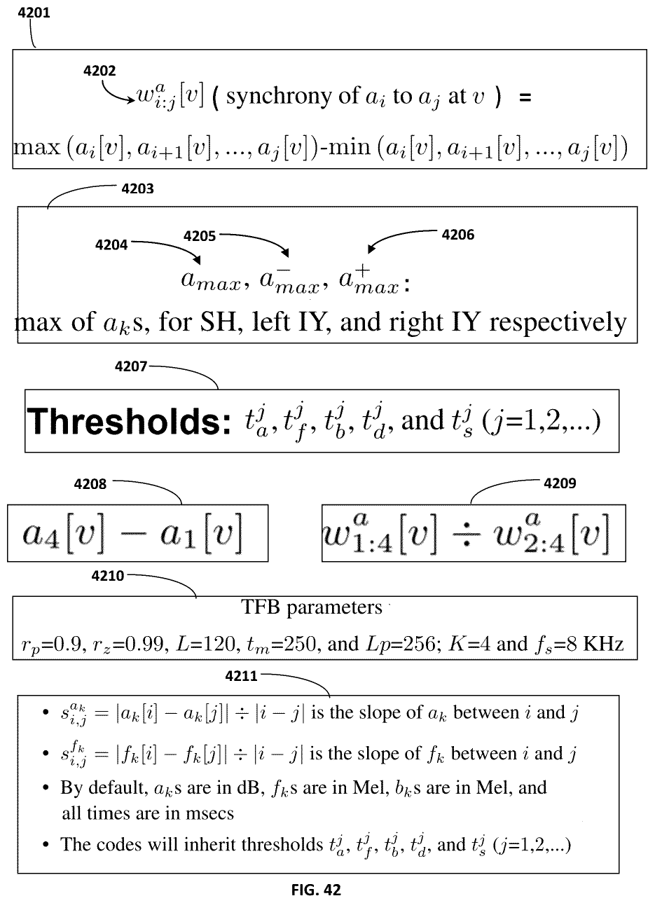

Here, results of analyzing utterances corresponding to AA-SH-AA, AA-T-AA, AA-R-AA, and AA-UW-AA, spoken by the same male speaker, using the same Motorola Z2 Force smart-phone, mentioned earlier, are presented; TFB parameters were also same as before. Before proceeding, some additional notations that will be used are listed in 4211 of FIG. 42. The thresholds in 4211 can be estimated using standard statistical (reference 3303) or deep learning (reference 3311) techniques. The sample thresholds provided for codes, were estimated by averaging over a training data-set of 10 gender balanced speakers (recording IY-SH-IY using the same handset); the thresholds involving entire resonance region, was done by averaging (across speakers) their maximum values in the resonance regions; and those involving specific times were simply averages across speakers.

### Phoneme AA-SH-AA:

Now consider an example of the same post-alveolar fricative consonant, SH, but with vowel, AA, as its left and right context. FIG. 701 displays the acoustic symbol for this SH. Observe that the symbol's shape in the resonance region is similar to that of the IY-SH-IY example (FIG. 201). Clearly, the phoneme's steady state characteristics do not change depending on its context. On the other hand, a comparison of the transition regions in symbols for IY-SH-IY (FIG. 201) and AA-SH-AA (FIG. 701) reveal that SH's transition symbol does depend on its adjoining phoneme context. In this specific case, it can be seen that during transitions AA-SH-AA exhibits larger rise/drop for a4, f2, and f3, relative to their values for IY-SH-IY.

Based on the above, the acoustic code for AA-SH-AA 4301 is as shown by equations 4302:4311, where the values of thresholds 4312:4324 are 19, 3, 0, 1500, 250, 125, 30, 500, 10, 100, 10, 500, and 50 respectively; the symbol * denotes the equations that are different for AA-SH-AA compared to its IY-SH-IY counterpart. Equations 4302, 4303, 4310, and 4311 are the main cues for this example.

Simulation Results for AA-SH-AA: The spectrogram for this example is shown in FIG. 801 and the MFB energies are shown in FIG. 802. First, notice that both indicate high energies in low frequency regions that correspond to typical characteristics of the AA phoneme. However, a) the demarcation between AA, SH, and AA is not precise, and b) the actual energy differences between high energy and low energy regions is unnoticeable.

Further, the spectrogram shows high frequency energy for SH, but the energies spill over into the adjacent AA regions due to windowing effects. Apart from these features, the spectrogram and MFB outputs, do not yield other cues specific to SH. On the other hand, FIGS. 803, 804, 805, and 806, display an entire set of cues that form a symbol, similar to the symbol in FIG. 701.

### Phoneme AA-T-AA:

The plosive consonants, also referred to as stop-consonants, have been known to have a very specific acoustic characteristic due to the complete closure of the vocal cavity prior to their “release burst” (reference 3201). They are defined by a closure interval, followed by a sudden burst of friction noise. However, it has been a major challenge to uniquely map plosives unless they are spoken with a very distinct closure; identifying their three places of articulations (alveolar, velar, and bilabial for T/D, K/G, and P/B respectively) being even more difficult.

In FIG. 901, the symbol for voiceless T is shown. Two additional time samples, ts, and tp, are considered. ts refers to the plosive's start. tp corresponds to the peak of the release burst. As shown in FIG. 902, a3 rises at the end of the preceding AA, then falls and then once again rises sharply before the onset of the next vowel, AA. The former drop is due to the sudden closure and the latter rise is due to the sudden opening for the release burst. Also notice that a3 rises the most and is above the rest of a1, a2, and a4, after release, for a very short duration

FIG. 903 shows that there are deviations in f3 during the closure and release intervals. Other features for this T include sharp drops followed by rises in a1, a2, and a4. Using all the above, the acoustic code for the AA-T-AA 4401 is as given by equations 4402:4412, where the values of thresholds 4413:4429 are 3, 20, 20, 3, 0, 10, 10, 50, 50, 30, 250, 10, 150, 20, 150, 5, and 20 respectively. Equations 4402, 4403, 4410, 4411, and 4412 are the main cues for this AA-T-AA example.

Simulation Results for AA-T-AA: In the spectrogram for this example (shown in FIG. 1001), the gap in energy just before 1000 msecs vaguely indicates a closure. On the other hand, the MFB outputs (FIG. 1002) do show drops in energies for all channels which are around 30 dB. Unfortunately, no other cues can be seen in both of their outputs. As for the TFB output, observe that FIGS. 1003, 1004, 1005, and 1006, trace a precise symbol for this plosive that resembles the one in FIG. 901; with specific drops in a1, a2 and a3 that exceed 30 dB; deviations in f2 and f3; deviations in b3 during closure, and a sudden absence of pitch for all channels.

### Phoneme AA-R-AA:

The symbol for the retroflex alveolar approximant, R, is shown in FIG. 1101. The phoneme R has been known to display (reference 3201) a very unique acoustic cue, namely a drop in f3 that results in smaller gap between f2 and f3. This can be clearly seen in FIG. 1103.
Additionally, FIG. 1103 also shows that the drop and subsequent rise in f3, during transitions, have specific slopes. Further on, it can be seen (from FIGS. 1102 and 1103) that a1, a2, a3, and a4 trace a specific symbol, b4 increases during resonance, and P1, P2, and P3 are present. Using these cues, the acoustic code for AA-R-AA 4501 is as given by equations 4502:4510; with the main cues being equations 4502 and 4503; and estimated the values of thresholds 4511:4518 being 2, 300, 750, 1000, 1700, 100, 10, and 50 respectively.
Simulation Results for AA-R-AA: The spectrogram and MFB outputs for this AA-R-AA example are shown in FIG. 1201 and FIG. 1202 respectively. Notice that MFB is unable to show any cues. However, the spectrogram does show the second and third resonances approaching close to each other. No other cues are visible using these signal processing methods.

The TFB outputs are plotted in FIGS. 1203 to 1206. Clearly, the f2 and f3 closeness is much more prominent; compared to the spectrogram. Additionally, a1, a21 a31 and a4 can be seen dropping for R, with a4 dropping by a much larger amount. Further the increase in b4 during R (between 1000 and 1500 msecs) is also very evident. And finally, the existence of pitch in channels 1, 2, and 3 in FIG. 1206 also agrees with the symbol of R shown in FIG. 1101.

### Phoneme AA-UW-AA:

The acoustic symbol for AA-UW-AA is shown in FIG. 1301. Similar to all vowels, UW has frequencies that follow the vowel triangle 1303. Further, UW includes specific pattern for its a1, a2, a3, and a4 (similar to AA) shown in 1302, with a1 and a2 being greater than a3 and a4. Additionally, as shown in 1303, b1 and b2 are in specified ranges, and P1, P2 are unity. The acoustic code for AA-UW-AA 4601 is as given by equations 4602:4608, with equations 4602 and 4606 being the main cues; and the values of thresholds 4609:4615 being 10, 3, 500, 600, 900, 750, and 100 respectively. The symbol for its related UH vowel is very similar, with f1 and f2 changing as per their locations in the vowel triangle.

Simulation Results for AA-UW-AA: FIG. 1401 and FIG. 1402 display the spectrogram and MFB outputs for this AA-UW-AA example. Once again, the MFB outputs fail to show any unique cues. While the spectrogram does show a drop in the first formant, the drop in the second formant and the closeness between first and second formants for UW is not clearly visible.

TFB's f1, f2, f3, and f4, plotted in FIG. 1404, clearly show the closeness between f1 and f2 that agrees with the vowel triangle characteristic for UW. Additionally, a1, a2, a3, and a4, plotted in FIG. 1403, reveal a symbol similar to the one derived for AA-UW-AA (shown in FIG. 1302). Further, b1, b2, b3, and b4, plotted in FIG. 1405, displays increase in b3 and b4, which also agrees with the portion of the symbol in FIG. 1303 that shows b: 3, 4. And lastly, FIG. 1406 shows the presence of pitch for channels 1, and 2, as indicated in FIG. 1303.

### 5.3 Performance Across Speakers

Next, the code was tested on a challenging IY-SH-IY data-set; 10 mixed-gender speakers enunciating poorly and speaking fast (median of t3-t2 was 90 msecs) recorded an utterance each, using the same mobile device. It was found that all speakers satisfied the main cues and several other cues. However, equations 4105, 4106, 4107, and 4111 were not satisfied by 4, 1, 6, and 3 speakers respectively. To address the latter, a confidence metric 4702, defined by equation 4701 has been computed (shown in Table 1501). It could be used, e.g. by a phoneme recognizer, to generate feedback, such as: display choices when the value of 4702 is 77% and 88%, prompt “speak clearly” if the value of 4702 is 66%, and have speakers repeat speaking for values of 4702 less than or equal to 5%.

### 5.4 Computational Complexity of TFB

In this section, the number of computations required by the TFB and MFB algorithms is compared. For TFB, three components that are needed to perform the adaptive filtering are considered. These include the DTF 113, the NM 116, and the AZF 112 (as shown in FIG. 101); the theory underlying the TFB algorithm is described in reference 3401. The module that performs frequency estimation using first-order linear prediction is ignored, mainly because a wide number of fast algorithms to do this have been proposed in literature (references 3104, 3303). To perform a fair comparison, for MFB (shown in FIG. 1502), the actual computation of the FFT is also ignored; given the numerous fast algorithms that have been proposed to calculate Fourier coefficients. Further, the actual computation of Mel features that are used for speech recognition (including Mel cepstrum, delta cepstrum, delta-delta cepstrum, etc.) are not accounted. Thus only the filtering algorithms for TFB and MFB are compared.

Table 1503 lists the number of additions, multiplications, and total calculations, needed for the TFB (with 4 channels) and the MFB (with 10 channels) algorithms. Clearly, MFB requires 25 times more calculations every second, compared to TFB. It is well known that several other filter banks (reference 3104), especially auditory models (references 3402, 3403, 3112, 3302, 3404), use many more filter channels (e.g. 64 channels between 100 Hz to 3827 Hz used in reference 3302 and perform many more calculations than MFB. Hence, one may argue that TFB is computationally superior to almost all currently used speech processing algorithms. The significant reduction in computations mainly stems from TFB's design around just 4 channels, each using simple (1-pole DTF and 3-zeros AZF) filters. This makes TFB attractive for low-cost hardware/software implementations.

### 5.5 Algorithm Tuning-Time-Frequency Filtering Matched to Speech

The effect of increasing TFB's DTF bandwidth for the IY-SH-IY example considered earlier is shown in FIGS. 1601 and 1602. A comparison of FIGS. 1601 and 1602 with FIGS. 303 and 304 shows that TFB is not very sensitive to the choice of rp. However, at very low values, a1, a2, a3, a4, and f1, f2, f3, f4 display relatively more fluctuations (due to energy leakage from other sub-bands), and the symbol gets distorted. On decreasing DTF bandwidths, TFB will fail to track f1, f2, f3, and f4, and not yield symbols; similar to fixed filter banks like MFB.

Next, the speech example considered for analyzing AA-SH-AA phoneme is considered. In FIGS. 1603 to 1606, the estimated tracks of a1, a2, a3, a4, and f1, f2, f3, f4, are shown for rp=0.2 and rp=0.99 respectively. Notice that for the former case, the estimates begin to display several fluctuations and f0 goes completely off-track at around 900 msecs. This is because by reducing rp to 0.2, we have essentially increased the bandwidth of the DTFs. This results in leakage of energies from adjoining resonances, which in turn biases the DTF estimates. For the latter example, the reverse can be seen. By making rp to be 0.99, we have significantly narrowed the DTFs bandwidths. As a result, the DTFs frequency estimates get relatively more smoother; thereby eliminating any real variations present in the f1, f2, f3, f4.

Next, the effect of changing bandwidths of the AZFs is considered. In FIGS. 1607 to 1610, the estimates of a1, a2, a3, a4, and f1, f2, f3, f4 are shown for rz=0.1 and rz=0.5 respectively. Notice that changes to the AZF bandwidths results in significantly worse estimates of f1, f2, f3, f4, compared to the change in DTF bandwidths that we saw earlier. In fact, for rz=0.1 TFB completely breaks down. This is because when the AZF bandwidth is made larger, in essence the resonance localization characteristic of the TFB is lost. As a result, sever leakage of resonance across channels occur, and hence estimates of f1, f2, f3, f4, become highly inaccurate.

Recall that TFB's NE module (114 in FIG. 101) non-linearly transforms the modulation features, so that their scales and regions of interest match the ones used in auditory system. Similarly, and based on the above simulations, one may argue that the parameter tuning of TFB is a form of time-frequency filtering “matched” to the known acoustic properties of speech. The matched filtering property may also be viewed as an approach to perform robust noise filtering. For instance, if a noisy signal has rapid frequency variations, then TFB will estimate a symbol for it which will not match any of the phoneme symbols. This could be used to filter out that noise portion. Obviously, the matched filtering may be fine-tuned to accents, languages, as well as other sampling rates (e.g. 16 KHz).

### 6. Unique Acoustic-Phonetic Mappings for English Language Phonemes

Since a phoneme's symbol is generally context dependent (discussed later), every example considered in this section includes a phoneme adjacent to it. Further, for simplicity, the same vowel, namely the “low and back” vowel AA (reference 3201), is used as left and right context. Hence, mapping of AA is discussed first, followed by all other English phonemes; the ones already considered in the section 5.2 are excluded.

6.1 Phoneme AA: The symbol for AA (only the resonance portion) is shown in FIG. 1701. Observe that the values of f1, f2, f3, f4 (shown in FIG. 1703) are related to AA's formant frequency locations on the vowel triangle (reference 3201) (shown in FIG. 1704). The new acoustic cues for AA include the relative values of the a1, a2, a3, a4; the ranges for b1 and b2; and the presence of sub-band pitch indicators, P1 and P2. The former is shown in FIG. 1702, and the latter are shown in FIG. 1703. Based on these cues, the acoustic code for AA 4703 is as given by equations 4704:4709, with the main cues being denoted by equations 4706 and 4707. The values of thresholds 4710:4716 are 5, 3, 600, 900, 900, 1300, and 50 respectively. The symbols for related vowels, namely AO, AE, EH, AX, AH, are very similar, but for f1 and f2 that change as per their locations within the vowel triangle for those phonemes.
6.2 Phoneme AA-ZH-AA: FIG. 1705 and FIG. 1706 display the symbol for ZH with AA context. Observe that except for the f1 part that is low, everything else is identical to AA-SH-AA's symbol, shown in FIG. 701. This agrees with ZH's property that it a voiced counterpart of SH and hence has prominent low frequency energy (sometimes referred to as the “voice bar”, reference 3201). Thus the acoustic code for AA-ZH-AA is same as equations 4302:4311, with an addition of equation 4717, where the value of threshold 4718 is 250. Equations 4302 and 4303, which were the main cues for AA-SH-AA, along with equation 4717, are the main cues for this phoneme.
6.3 Phoneme AA-CH-AA: The affricate CH has many of the acoustic properties of the fricative SH. Additionally it has a certain plosive like characteristic due to its labio-dental place of articulation (reference 3201). Thus the symbol for CH, shown in FIG. 1801, is a right tilted version of SH's symbol (FIG. 701); which makes it asymmetric in a1, a2, a3, a4 (as shown in FIG. 1802) and f1, f2, f3, f4 (shown in FIG. 1803). Further, the resonance duration of CH is very short. Based on these cues, the acoustic code for AA-CH-AA 4801 can be expressed by equations 4802:4813. The values of thresholds 4814:4828 for this phoneme were estimated as 19, 3, 10, 10, 5, 0, 1500, 250, 300, 100, 125, 10, 100, 10, and 100. Equations 4802, 4803, and 4812 are the main cues for this example.
6.4 Phoneme AA-JH-AA: FIGS. 1804 and 1805 display the symbol for JH with AA context. Similar to the difference between SH and ZH, the symbol for AA-JH-AA is identical to AA-CH-AA's symbol, except for the f1 part that is low (due to the voice bar). Thus the acoustic code for AA-JH-AA 4801 is same as equations 4802:4813 with an addition of equation 4901, and with the value of threshold 4902 being 250. Equations 4802, 4803, 4812, and 4901 are JH's main cues.
6.5 AA-S-AA: The voiceless fricative consonant, S, has an alveolar place of articulation. Earlier acoustic phonetic research indicate that this phoneme has its energy concentration in a higher frequency region (4000-7000 Hz) compared to that of SH; otherwise most of its characteristics are similar to SH, which makes it very difficult to distinguish S from SH. However, this section presents several new findings that demonstrate a unique mapping of AA-S-AA.

The symbol for S is shown in shown in FIG. 1901. First, observe that the f1, f2, f3, f4, in FIG. 1903 are slightly lower compared to the ones for SH shown in FIG. 703. Next, from FIG. 1902 it can be seen that the a1, a2, a3, a4, are very different to those of SH presented in FIG. 702. Specifically, a4 is not significantly higher than a1, and a4 is not grouped closely with a1. Further, for AA-S-AA, it is clear that its peak amplitude drops relative to the neighboring vowels; as opposed to that for SH. And finally, the slopes of a4 during transitions, are not as dramatic as they are for SH. Putting all this together, the acoustic code for AA-S-AA 4903 is as given by equations 4904:4911, where equations 4904, 4905, 4910, form the main cues; and the values of thresholds 4912:4921 are 5, 5, 5, 1300, 250, 150, 30, 500, 10, and 100 respectively.

6.6 Phoneme AA-Z-AA: FIG. 1904 and FIG. 1905 display the symbol for AA-Z-AA. Once again, except for the f1, f2, f3, f4 part that is low, everything else is identical to symbol of AA-S-AA. This agrees with Z's property that it a voiced counterpart of S and hence it inherits a voice bar as a result of vibrations of the vocal folds (reference 3201). Thus the acoustic code for AA-Z-AA is same as equations 4904:4907 and equations 4909:4910 with the exception of equation 4908 being changed to equation 4922, where the values of threshold 4923 is 150; Equations 4904, 4905, 4910, and 4923 are its main cues.
6.7 Phoneme AA-F-AA: The symbol for AA-F-AA is shown in FIG. 2001. It is very similar to the symbol of AA-S-AA (FIG. 1901), with some differences (shown in FIGS. 2002 and 2003) as follows. First, the duration of F is small, due to the known property of F that it is a voiceless labiodental fricative. Next, observe that a2 and a3 have an inverted U shape, as opposed to the corresponding U-shaped drops for S. This inverted U for F, suggests a drop-rise-drop symbol that is also consistent with the phoneme's labiodental place of articulation; the articulators movement from the AA left context results in an immediate drop, followed by the rise due to release of the fricative sound, and again followed by a drop due to the release for onset of the right AA vowel. The acoustic code for F 5001 is as given by equations 5002:5013, with equations 5002, 5003, 5004, and 5012 being its main cues; and the values of thresholds 5014:5026 are 5, 3, 3, 3, 5, 5, 1300, 250, 150, 5, 30, 1, and 5 respectively.
6.8 Phoneme AA-V-AA: The symbol for AA-V-AA is shown in FIGS. 2004 and 2005. Except for the f1 part that is low, everything else is identical to the symbol of AA-F-AA (FIGS. 2002 and 2003). This once again agrees with V's property that it a voiced counterpart of F. Thus, the acoustic code for AA-V-AA is same as that of AA-F-AA (equations 5002:5013) with an addition of equation 5101. Equations 5002, 5003, 5004, 5012, and 5101 form the main cues for AA-V-AA, with the value of threshold 5102 being 150.
6.9 Phoneme AA-HH-AA: FIG. 2101 displays the symbols for the glottal fricative AA-HH-AA. Similar to many fricatives, observe that its a4 rises slightly above a1. But HH's uniqueness is that the rise in a3 over a2, happens around the same time as a4 rises. When the SNR is low, a4 and a3 may not actually exceed a1 and a2 respectively; instead, they would exhibit inverted U-shapes around resonance time.

Also, phonetic studies reveal that HH sound is due to lack of any constriction in the vocal cavity and that HH has a very short duration. The result is an acoustic cue for HH that its values for f1, f2, f3, f4, same as their corresponding values for preceding context vowel. Another interesting characteristic of HH stems from linguistics. Basically, HH cannot be an independent phoneme, and always needs to have a vowel following it. All of these cues stitched together result in the following acoustic code for HH 5103 is as given by equations 5104:5110, where fj [t2] is the value of fj at t2 for the preceding AA vowel. The main cues for AA-HH-AA are denoted by equations 5104, 5107, and 5110. The values of thresholds 5111:5117 are 3, 3, 0, 200, 150, 5, and 30 respectively.

6.10 Phoneme AA-IY-AA: The symbol for IY is shown in shown in FIGS. 2104, 2105, and 2106. As shown in FIG. 2105, IY has frequencies that follow the vowel triangle FIG. 2106. Further, as seen in FIG. 2104, a2 is below both a1 and a3, during IY's resonance. Even further, f2 and f3 are grouped closely together, relative to their separation from f1. Additionally, the cues for IY include specific ranges for b1 and b3, and the presence of P1 and P3. The acoustic code for AA-IY-AA 5201 is as given by equations 5202:5209, with its main cues being denoted by equations 5202, 5203, and 5205. The values of thresholds 5210:5220 are 3, 10, 2, 5, 3, 2.5, 250, 400, 1500, 2000, and 150 respectively. The symbol for its related IH vowel is very similar, but for f1 and f2 that change as per their locations in the vowel triangle for IH.
6.11 Phoneme AA-Y-AA: The acoustic symbol of the approximant AA-Y-AA is displayed in FIG. 2201. Observe that the f1, f2, f3, f4 (FIG. 2203) are identical to its IY counterpart (FIG. 2106). However, its a1, a2, a3, a4 (shown in FIG. 2202) are very different. Their drop is relatively more compared to that in AA-IY-AA; mainly because Y is a weak consonant. More importantly, notice that a4 has an inverted U shape as it attempts to rise above a1 at peak resonance time. And finally, it is known that the duration for the semi-vowel Y is relatively small, compared to its IY vowel counterpart. Using all this, the acoustic code for AA-Y-AA 5301 is as given by equations 5302:5309, with Y's main cues being denoted by equations 5302, 5304, and 5309; and the values of thresholds 5310:5320 being 0, 5, 3, 2.5, 250, 400, 1500, 2000, 150, 10, and 20 respectively. Finally, phonetics study indicate that Y can never occur independently, but is always attached to a vowel; AA to the right in this example.
6.12 Phoneme AA-W-AA: The differences between AA-UW-AA and AA-W-AA are very similar to the differences between AA-IY-AA and AA-Y-AA. This can be seen from its symbol shown in FIGS. 2205, 2206, and 2207. Notice that this semi-vowel has identical f1, f2, f3, f4 as its vowel counterpart, UW, but very different a1, a2, a3, a4, which display a high frequency rise. The acoustic code for AA-W-AA 5401 is as given by equations 5402:5409. The main cues for AA-W-AA are denoted by equations 5402, 5406, and 5409; the values of thresholds 5410:5419 are 0, 5, 3, 500, 600, 900, 750, 150, 10, and 20 respectively.
6.13 Phonemes AA-M-AA and AA-N-AA: The symbols for nasal sounds, M and N, are shown in FIG. 2301. It is known that nasals are characterized by complex coupling of resonances from the vocal and nasal cavities (reference 3201). It is known that nasals have a prominent low-frequency energy, whose frequency is the lowest of all phonemes. This can also be seen in the symbols of M and N, displayed in FIG. 2301; as indicated by dips in f1 during t2:t3 in FIG. 2303 and FIG. 2305. Nasals are also characterized by broad bandwidths relative to vowels, and presence of anti-formants (nulls in the signal's magnitude spectrum) at specified locations. Unfortunately, these cues have not been enough to uniquely map nasals in the past; especially since their low-frequency energy resemble that of the IY phoneme.

However, FIG. 2301 shows that nasals inherit several other unique cues. First, a valid b2 and P2 in the resonance region result in presence of a valid f2; which is not the case for IY. Next, their nasal-vocal coupling characteristics, gives these phonemes a unique symbol for a1, a2, a3, a4, wherein a1, a2, and a3 are grouped very close together, relative to the huge dip in a4. Further, since nasals also have severe constriction, the symbol also indicates an overall fall in its maximum amplitude relative to the context vowels.

The difference between M and N are subtle, but noticeable. First, the falls in a4 and f1 are very abrupt for M, as opposed to N. This is because M is a bilabial phoneme that inherits a sudden drop in air-flow as opposed to the gradual drop of the alveolar nasal, N. Also, ranges of b3 and b4 are in specified low bandwidth ranges for M, but for N they are relatively very high. This correlates with the presence of anti-formants that are at higher frequency for N, compared to M. The bandwidth cues also correlate well with anti-formants-filter nulls interacting with filter poles can result in increased bandwidths at the null location of a magnitude spectrum.

By taking all the above cues into account, the acoustic code for AA-M-AA 5501 is as given by equations 5502:5512, with the main cues being denoted by equations 5502, 5504, 5507, 5509, 5510, 5511, and 5512; with the values of thresholds 5513:5527 being 2, 3, 250, 400, 1000, 1700, 1500, 2000, 150, 3, 100, 30, 500, 10, and 50 respectively. And the acoustic code for AA-N-AA 5601 is as given by equations 5602:5612, with the main cues being denoted by equations 5602, 5604, 5607, 5609, 5610, and 5611; and the values of thresholds 5613:5627 are 3, 3, 250, 400, 1000, 1700, 1500, 2000, 150, 3, 100, 30, 500, 50, and 100 respectively.

6.14 Phonemes AA-L-AA: The acoustic characteristics of L, a lateral alveolar approximant, are somewhat similar to nasals. This is because the articulation for L is such that air escapes on either sides of the oral cavity constriction, creating a condition similar to air escape from the nasal region. While this has posed questions about its unique cues, this section shows that L can also be mapped by a symbol that is different from nasals.

The symbol for L is shown in FIG. 2401. Specifically, FIG. 2403 shows that the f2, f3, f4 of L are similar to nasals, but not f1. Notice that f1 for L, during resonance, is higher than its corresponding values for M and N. A cue that stands out even more is the shape of a3. By comparing FIG. 2402 with FIG. 2302, it should be evident that a1 and a2 are grouped together, and a3 is mid-way between them and a4; as opposed to all three being grouped together for nasals. As for other features, b1, b2, b3, b4 are similar to that of M and pitch indicator, Pks, are same as M and L. Based on all this, the acoustic code for L 5701 is as given by equations 5702:5713, with the main cues being denoted by equations 5603, 5605, 5610, 5611, 5612, and 5702; and the values of thresholds 5714:5730 are 3, 0.8, 1.2, 3, 300, 500, 1000, 1700, 1500, 2000, 150, 2, 100, 30, 500, 50, and 100.

6.15 Phonemes AA-D-AA, AA-K/G-AA, AA-P/B-AA: D is simply the voiced counterpart of the voiceless plosive T. Thus, the symbol for D (displayed in FIG. 2404) is identical to T's symbol (FIG. 901), as seen in FIGS. 2405 and 2406, except for the low f1 (FIG. 2406); a result of the voice bar. Thus the acoustic code for AA-D-AA is same as equations 4402:4412, with the addition of equation 5801, with values of thresholds 5802 and 5803 being 250 and 400 respectively; and with equations 4402, 4403, 4410, 4411, 4412, and 5801, being the main cues.

The example of K is considered in FIG. 2501. It is similar to the AA-T-AA example (FIG. 901) except that instead of a3, the most dominant amplitude during burst release is a2. Also, instead of the deviations in f3, they now occur in f2. And finally, unlike the rise of a3 in preceding vowel for T, there is no rise in a2 for K. The resulting acoustic code for AA-K-AA and its voiced version AA-G-AA (symbol in FIG. 2504 and FIG. 2505) 5901 is as given by equations 5902:5912. Equations 5902, 5909, 5910, and 5911 are the main cues for AA-T-AA; and AA-G-AA has an additional main cue denoted by equation 5912; and the values of thresholds 5913:5928 are 20, 3, 0, 10, 50, 50, 30, 250, 10, 150, 20, 150, 5, 20, 250, and 400.

Finally, the velar plosives, P and B, are shown in FIG. 2601. As seen in FIGS. 2602, 2603, 2604, and 2605, for these phonemes, there are no deviations in f1, f2, f3, f4 and there are no rises in any of a1, a2, a3, a4. However, all a1, a2, a3, a4, fall into the closure region and then have a steep rise into the following vowel. The acoustic code for P/B 5804 is as given by equations 5805:5808, with equations 5805, 5806, being the main cues for AA-P-AA; with the values for thresholds 5809:5814 being 10, 5, 5, 3, 250, and 400; with AA-B-AA having an additional main cue denoted by equation 5808. As a comment, acoustic phonetic and linguistic studies have shown that none of the plosives can occur independently. They are always sandwiched with a vowel on right; the single plosive cases can be viewed as a plosive joined to the UH vowel (T-UH, K-UH, etc.).

6.16 Phonemes AA-TH-AA, AA-DH-AA: The phoneme TH/DH is the combination of T and HH that were presented earlier (FIG. 901 and FIG. 2101 respectively). As a result, its acoustic symbol (shown by FIGS. 2702:2705) is similar to that of T with one extra feature in the symbol of a1, a2, a3, a4. This is shown in FIGS. 2702 and 2704, wherein a1 is tilted right immediately after 12. It results in an area with a noticeable gap between a3 and a1; somewhat similar to the one we saw for CH. The acoustic code for TH/DH has all the equations that mapped T/D, with the new addition shown in 5815. In addition to the main cues for AA-T-AA/AA-D-AA, TH/DH would have equation 5816 as an additional main cue; the values of thresholds 5818, 5819, and 5820 are 3, 250, and 400 respectively.
6.17 Diphthongs: Diphthongs, which are known to exhibit rapid transitions between vowels, could be mapped by combining the symbols of the individual phonemes forming the diphthong. As an example, the acoustic code for AY (symbol in FIGS. 2802 and 2803 shown in FIG. 2801) 6001 is as given by equations 6002:6013, where equations 6002 to 6007 belong to the AA part of AY, and 6008 to 6012 belong to the Y part of AY that lasts only for a very short time around 13. Equation 6013 denotes the rapid transitions between AA and Y that form AY. The main cues for AY are denoted by equations 6002, 6003, 6009, and 6013. The values of thresholds 6014:6030 are 5, 3, 600, 900, 900, 1300, 50, 0, 5, 2.5, 250, 400, 1500, 2000, 150, 10, and 20.

As another example, the acoustic code for AW (symbol in FIGS. 2804 and 2805 shown in FIG. 2801) 6101 is as given by equations 6102:6113, where equations 6102 to 6107 belong to the AA part of AW, and 6108 to 6112 belong to its W part that lasts only for a very short time around 13. Equation 6113 denotes the rapid transitions between AA and W. The main cues for AW are denoted by equations 6102, 6103, 6111, and 6113. The values of thresholds 6114:6129 are 5, 3, 600, 900, 900, 1300, 50, 0, 5, 500, 600, 900, 750, 150, 10, and 20.

6.18 Extension to Map Accented and Non-English Phonemes: Clearly, the method described so far, which is based on modeling the synchrony in a1, a2, a3, a4, f1, f2, f3, f4, b1, b3, b3, b4, and P1, P2, P3, P4, could be easily extended to handle a variety of different phonemes; across a range of accents and languages. As an example, consider a phoneme R (shown in FIG. 2901) that is spoken by using the tongue to apply pressure onto the palate and holding it there. Let us call this phoneme R1. Its symbol is shown in FIGS. 2902 and 2903. Notice that in addition to the cues of R, R1 displays an additional cue shown as a significant dip in f4. Using this, R1's acoustic code 6201 can be written using equations 6202:6213, where the main cues are denoted by equations 6203, 6204, 6211, and 6212; the values of thresholds 6214:6224 are 3, 1000, 300, 750, 1000, 1700, 2700, 100, 10, 150, and 50.

As another example, consider the trill R spoken in many languages like Italian, Spanish, Hindi, etc. The symbol for this phoneme (referred to here as RR) is shown FIGS. 2904 and 2905. Observe that unlike the previous Rs, RR does not display deviations in either f3 or f4. Instead, it shows oscillations in a1 and a2 during resonance. This AA-RR-AA phoneme can be mapped using the acoustic code shown in 6301 that is based on equations 6302:6306, where 6307 is the average of amplitudes (a1 or a2 or a3 or a4) over the resonance interval, 12:13. Basically, equation 6306 models the oscillations in a1 and a2 using a 6.5 Hz sine wave. The values of thresholds for 6308:6310 are 750, 150, and 2. Alternatively, this equation may be replaced by a more complex one, which minimizes the sum of squared errors using a parametric model fitted to the oscillating a1, a2, a3, a4, like the one shown in 6311, where 6312 is the least-squares error being minimized; the model parameters may be estimated using standard analysis techniques (reference 3303).

7. Phonemes with Different Left and Right Context

FIG. 3001 displays the symbol for IY-SH-AA. By comparing this with FIG. 201 and FIG. 701, it should be clear that the resonance part of a phoneme's symbol never changes, but its transition part does; the latter depending on the phoneme's context. Specifically, observe that none of f1, f2, f3, f4 change in FIG. 203. This is because of the similarity between f1, f2, f3, f4 during resonance of SH and IY. In contrast, notice that in FIG. 3003, f1, f2, f3, f4 for SH are same as the left IY vowel but they change as SH transitions into its right AA vowel.

The same behavior can be seen for the a1, a2, a3, a4, in FIG. 202 and FIG. 3002, i.e. the pattern a3>a2>a1>a4 changes while transitioning into resonance, and it changes again while transitioning out of resonance to a3>a2>a1>a4 (in case of IY-SH-IY) and a2>a1>a3>a4 in case of IY-SH-AA. Obviously, the acoustic codes for IY-SH-IY and IY-SH-AA may be easily derived by combining appropriate parts of acoustic codes for IY-SH-IY and AA-SH-AA.

### 8. Relationship Between Modulation Vector and Spectral Envelope

In this section, it is shown that the shape of a signal's spectral envelope, may be expressed using elements of the modulation vector. This concept may be further extended to model signals, like speech, whose spectral envelope shapes change with time. First, let us extend well-known ideas from digital filter theory (reference 3405), to classify spectral envelope shapes into low-pass (LP), high-pass (HP), and mixed-pass (MP) types. In FIGS. 3004 and 3008, some spectral envelopes are shown; 3005 is labeled LP, 3006 is labeled HP1, and 3007 are labeled HP2. By combining a1, a2, a3, a4 and f1, f2, f3, f4, we can express these as shown in 6401, where ta is the pass-band to stop-band attenuation threshold, and tf is the band-edge frequency threshold.

As another example, FIG. 3008 considers a 3-peak LP (FIG. 3009) and a 2-peak LP with noise at f2 (FIG. 3010). They can be modeled as shown in 6402. Additionally, FIG. 3010 may be further modeled using 6403, where b2, along with threshold tb, is used to model noise.

And finally, consider an example of a signal slowly transitioning from LP to HP1 to LP. To model the HP1 part, a symbol as shown in 3011 may be created and a code derived as shown in 6404, where t1, t2, 13 are times for transition onset, resonance, and transition offset respectively. Notice how the set of minimalist equations shown in 6404 model HT1 using synchrony of a1, a2, a3, a4 and f1, f2, f3, f4 between times t1 and 13.

### 9. Using Bandwidth Estimates to Detect Mismatch Between Signal and TFB

In this section it is shown that the TFB channels' bandwidth estimates may be used to detect missing resonances, which would happen if TFB is not matched to the signal's characteristics. For example, consider the example in FIG. 3010 where there are only 2 resonances, and noise in-between them. Obviously, it this signal is processed by a 3-channel TFB, then one of the channels will be located at the center frequency of noise spectral envelope.

However, notice that the bandwidth of the noise resonance is larger than those of the neighboring resonances. This may be used to detect that the signal has simply 2 resonances, and hence the number of TFB's channels should also be set to be 2. This occurs sometimes for speech sounds like the IY vowel, which has a large gap between 1st format and 2nd formant; which could be occupied by noise.

### 10. Discussions

The acoustic symbols and codes derived for all English language phonemes (documented in section 6) indicate that a) the latter may be mapped to unique context-dependent shapes (similar to FIG. 201) and machine-readable rules (similar to equations 4103:4111), which the spectrogram and MFB fail to accomplish; and b) all acoustic cues reported in earlier studies (reference 3201) correlate well, but with only a sub-set of cues rendered by the symbols.

In general, each phoneme inherits a maximum of 6 symbols depending on the phoneme that precedes and follows it. Specifically, it depends on whether the adjoining phonemes spectral envelope (reference 3312) shapes are LP, HP, or MP. For example, if a phoneme is of type HP (like SH), then it can have context dependent symbols corresponding to the combinations LP-HP-LP, LP-HP-HP, LP-HP-MP, HP-HP-LP, HP-HP-HP, HP-HP-MP, MP-HP-LP, MP-HP-HP, and MP-HP-MP. While these amount to a total of 9 combinations, some of them get eliminated due to the phoneme's articulatory and linguistic constraints, resulting in a maximum of 6 symbols per phoneme. Such a context-dependent design renders itself to superior noise detection capability—e.g., a background vehicle noise resembling SH's spectrum may be easily detected since its symbol will differ from that of IY-SH-IY, IY-SH-AA, etc.

The parameters of all the acoustic codes presented in this document, were derived assuming standard speaking styles. For speakers who have certain specific accents, the parameters may be adapted. Additionally, depending on the application, duration and other code equations may be added; to address effect of context, symbol scaling, signal quality, noise, etc. Further, for certain applications that cannot tolerate high rejection thresholds (e.g. limited vocabulary data-entry in noisy environments) or that prefer to force a best matching output for further manual processing (e.g. dictation data recorded by a device that a medical transcriptionist processes), the code thresholds may be estimated using receiver operating characteristics (ROC) based concepts (reference 3303). More generally, instead of simple sampling of symbols to generate codes (done mainly to mitigate variability) may be replaced by other types like a) estimate probability of code equations in resonance region, and b) use of complicated mathematical methods to model the symbols.

As mentioned in section 1, only part of the modulation vector was considered for all the analysis. The reason for this is as follows—for most phoneme sounds, it has been observed that the traces of f1, f2, f3, f4 and fc1, fc2, fc3, fc4 (and hence their associated a1, a2, a3, a4 and ac1, ac2, ac3, ac4 respectively) are very similar. However, for some phonemes, like nasals, this is not the case. This could be because nasals have anti-formants between resonances. This is currently being studied further. In general, the redundancy in the modulation vector helps to perform sanity checks on the final features.

Experiments reveal that some of the code equations (e.g. equations 4105:4107 and 4111, for IY-SH-IY) are not always satisfied for speakers enunciating poorly (reference 3314); reinforcing the challenge of variability in speech. Interestingly, the code structure resembles layers of linear transforms coupled with non-linearities, seen in deep learning neural networks (references 3406, 3311). For instance, equation 4103 is a linear combination of a4[v] and a1 [v], followed by a non-linearity (>ta1), where each a1, a2, a3, a4 is output of linear filters (convolutional AZF 112 and recurrent DTF 113 in FIG. 101) that is non-linearly transformed by NE 114. Further, notice that the codes jointly model phoneme transitions and resonances. Further they sample the symbols at specific times, which is similar to the “attention” concept used in transformers (reference 3311). These new insights may be used to estimate code thresholds, in a way that the resulting codes enable speech recognition systems to require lesser training data, and be more robust to training-testing model mismatch (references 3102, 3103).

By extending the confidence metric concept to word levels, superior confidence models (reference 3407) may be built for speech understanding (reference 3407) and multi-modal (reference 3408) systems. For instance, a word level confidence metric could be simply gotten by summing the individual confidences for all the phonemes that make up the word. Alternatively, syllable level confidences could be used. Further, a weighted average of confidence metrics could be used depending on syllable stress pattern, pitch contour within the word, language model for the specific application etc.

Further, advanced voice analytics (reference 3409) may also be performed. For example, if a4 [v]-a1 [v]>30 in equation 4103 then it indicates that the SH is being spoken loudly; if the threshold 4113 in equation 4104 is greater than 10, then it indicates that the SH is being enunciated very clearly; if the threshold 4114 in equation 4105 is negative, then it indicates that IY was spoken loudly, relative to its following SH phoneme; if t3-t2=50 in equation 4109 then the speaker is speaking very fast; and so on.

It can also be shown that TFB's resonance localized modulation tracking (FIG. 101) mimics the frequency localized temporal processing (reference 3109) in the human ear's cochlea (reference 3307). For instance, the AZF-DTF 112-113 frequency response, which gets shaped by the masking of NM 116, is similar to the tonotopic coding on the basilar membrane (BM). The temporal processing by DTF-MFE 113-111 resembles the complex coupling between BM, the outer hair cells (OHCs), and the active amplification proposed by many auditory models (references 3410, 3411, 3412, 3313, 3204). And finally, the transformations in NE closely follow the non-linearities in inner hair cell (IHC) outputs. Based on this, one may envision extending TFB to model the joint place-time theory of auditory processing, so as to improve applications like speech synthesis, voice biometrics, cochlear implants, and hearing aids.

And finally, the time-alignments that form part of the acoustic symbols (e.g., t1, 12, 13, 14, in FIG. 201, can be manually computed; or estimated using standard acoustic model training techniques, like the Baum-Welch algorithm (reference 3413); or an algorithm to automatically estimate these, without resorting to any training data, may be built.

Those familiar with art will recognize that the system and method of mapping phonemes proposed in this invention may be extended to several other applications including music synthesis and analysis, speaker identification, biological signal processing, analysis of any kind of 1-dimensional data (e.g. for prediction of stock, earthquakes, volcanoes, weather, etc.). More generally, the three concepts (signal representation, matched filtering, synchrony) may be extended to other areas like face recognition, computer vision, language processing etc.

The claimed invention is:

1. A system and method for mapping phonemes to acoustic symbols and codes, the system comprising:
a) a modulation vector module representing acoustic resonances in speech signals using a hybrid of the sum of sinusoids model and a generalized modulation model;
b) a resonance localized filter bank that estimates and tracks the modulation vector; and
c) a synchrony module utilizing simultaneous evolution of the modulation vector, within and across resonances, to derive acoustic symbols and acoustic codes that uniquely map fundamental language units, phonemes.

2. The system of claim 1, wherein the modulation vector comprises of one or more acoustic features characterizing speech resonances; including amplitudes, frequencies, bandwidths, pitch, and other parameters.

3. The system of claim 2, wherein the features denoted by modulation vector are non-linearly transformed to match the auditory scale and region of interest.

4. The system of claim 3, wherein the auditory scale refers to scales like decibels for amplitudes; logarithmic or MEL for frequencies and bandwidths; Hz for pitch; and so on; and the region of interest refers to ranges like 0-2000 Hz for first resonance, 0-300 Mel for bandwidths, 0-400 Hz for human pitch and so on.

5. The system of claim 1, wherein the filter bank parameters are chosen such that the resulting time-frequency filtering is matched to the acoustic symbols of phonemes.

6. The system of claim 1, wherein the filter bank is implemented using an adaptive signal processing algorithm, or as a fixed filter bank followed by channel selection algorithm, or a time-frequency transformation.

7. The system of claim 1, wherein the synchrony module jointly models the acoustic transitions and steady-state resonances of phonemes.

8. The system of claim 1, wherein the synchrony module employs relationship between the modulation vector and the speech spectral envelope, along with known acoustic-phonetic characteristics of phonemes, to derive unique phoneme specific patterns or symbols.

9. The system of claim 8, wherein the synchrony module employs bandwidth estimates to further refine the acoustic-phonetic symbols and codes.

10. The system of claim 1, wherein the acoustic codes are implemented using equations that model the shapes of acoustic symbols, or directly using acoustic-phonetic reasoning equations, and/or parametric models, and/or statistical modeling techniques, and/or deep learning neural networks.

11. The system of claim 10, wherein the acoustic codes yield a unique acoustic-phonetic map called the speech code, for the entire language.

12. The system of claim 1, wherein well-known speech processing methods, techniques, and algorithms, are used to further improve accuracy, speed, and noise robustness capability of the overall system.

13. The system of claim 1, wherein a variety of different acoustic symbols and codes are derived depending on the signal's sampling frequency, the signal-to-noise ratios, background noise environments, speaking styles, and so on.

14. The system of claim 1, further comprising an input module cond that accepts a speech waveform by a user.

15. The system of claim 1, further comprising an output module that yields acoustic symbols and codes, mapping the acoustic-phonetic speech code.

16. The system of claim 1, wherein the method is implemented as software and/or hardware.

17. The system of claim 1, wherein the method is implemented on a device or resides on a network or server.
